(19) United States
(12) Patent Application Publication
(10) Pub. No.: US 2015/0052372 A1
(43) Pub. Date: Feb. 19, 2015

(54) COMPUTING SYSTEM WITH RESOURCE MANAGEMENT MECHANISM AND METHOD OF OPERATION THEREOF

(71) Applicant: Samsung Electronics Co., Ltd., Suwon-si (KR)

(72) Inventors: Kaushik Barde, Sunnyvale, CA (US); Jitendra Kulkarni, San Jose, CA (US); Chenjie Luo, Santa Clara, CA (US); Simon Bloch, Mountain View, CA (US)

(73) Assignee: Samsung Electronics Co., Ltd., Suwon-si (KR)

(21) Appl. No.: 14/286,183

(22) Filed: May 23, 2014

Related U.S. Application Data
(60) Provisional application No. 61/866,943, filed on Aug. 16, 2013.

(51) Int. Cl. G06F 1/32; G06F 9/44

(52) U.S. Cl. CPC G06F 1/32; G06F 8/30
USPC 713/300; 713/320

(57) ABSTRACT

A computing system includes: a storage interface configured to access an application code including a target code; a control unit, coupled to the storage interface, configured to: identify a consumption model corresponding to the target code, calculate a consumption estimate for the target code based on the consumption model, and generate a code-power analysis output based on the consumption estimate.

### CROSS-REFERENCE TO RELATED APPLICATION(S)

This application claims the benefit of U.S. Provisional Patent Application Ser. No. 61/866,943 filed Aug. 16, 2013 and the subject matter is incorporated herein by references thereto.

### TECHNICAL FIELD

An embodiment of the present invention relates generally to a computing system, and more particularly to a system with a resource management mechanism.

### BACKGROUND

Modern consumer and industrial electronics, especially devices such as computing systems, cellular phones, portable digital assistants, and combination devices are providing increasing levels of functionality to support modern life including online social networks. Research and development in the existing technologies can take numerous different directions.

As users become more empowered with the growth in computing, various uses begin to take advantage of this new device space. One such advancement has prolonging usage of the device between battery charging opportunities in light of increasing demand on energy correlated with increasing functionality and usage cases.

Thus, a need still remains for a computing system with power management mechanism. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment provides a computing system, including: a storage interface configured to access an application code including a target code; a control unit, coupled to the storage interface, configured to: identify a consumption model corresponding to the target code, calculate a consumption estimate for the target code based on the consumption model, and generate a code-power analysis output based on the consumption estimate.

An embodiment provides a method of operation of a computing system including: accessing an application code including a target code; identifying a consumption model corresponding to the target code; calculating a consumption estimate for the target code based on the consumption model; and generating a code-power analysis output with a control unit based on the consumption estimate.

An embodiment provides a non-transitory computer readable medium including instructions for operating a computing system including: accessing an application code including a target code; identifying a consumption model corresponding to the target code; calculating a consumption estimate for the target code based on the consumption model; and generating a code-power analysis output with a control unit based on the consumption estimate.

An embodiment provides a graphic user interface to exchange information related to an application, the graphic user interface displayed on a user interface of a device, including: an identification portion configured to display an application identification and a user profile; and a descriptive portion configured to display an average usage corresponding to the user profile and the application identification, and display a consumption rating associated with the average usage for representing a consumption model corresponding to the user profile and the application identification.

An embodiment provides a computing system, including: a sensor configured to determine a consumption measurement for representing a device executing an application; a control unit, coupled to the sensor, configured to: identify an input sequence corresponding to the consumption measurement, generate a state model based on the consumption measurement, the input sequence, or a combination thereof, and generate a consumption model based on the state model for representing the application based on the device.

This summary section is provided merely to introduce certain concepts and not to identify any key or essential features of the claimed subject matter. Certain embodiments of the invention can have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

Accompanying drawings show one or more embodiments; however, the accompanying drawings should not be taken to limit the invention to only the embodiments shown. Various aspects and advantages will become apparent upon review of the following detailed description and upon reference to the drawings in which:

FIG. 1 is a computing system with power management mechanism in an embodiment of the present invention.

FIG. 2 is an example block diagram of the computing system.

FIG. 3 is a further example block diagram of the computing system.

FIG. 4 is an example display of the computing system.

FIG. 5 is a further example display of the computing system.

FIG. 6 is an additional example display of the computing system.

FIG. 7 is a control flow of the computing system.

FIG. 8 is a detailed example of the analysis module of FIG. 7.

FIG. 9 is a detailed example of the consumer module of FIG. 7.

FIG. 10 is an exemplary flow chart of a method of operation of a computing system in a further embodiment.

### DETAILED DESCRIPTION

The following embodiments of the present invention can be used to access information regarding resource consumption. A consumption model can be generated to characterize behaviors associated with the resource consumption for an application, a specific device, or a combination thereof. An analysis environment can be used to determine and compare input sequence and consumption measurement. The analysis environment can further determine a state model corresponding to application call, system call, or a combination thereof. The analysis environment can generate the consumption model based on the state model.

The consumption model can be used in a development environment for developing the application through application code. The development environment can analyze the application code to generate the code-power analysis output for optimizing resource consumption. The code-power analysis output can communicate information regarding behavior associate with resource consumption, generate replacement code for replacing target code, or a combination thereof for optimizing resource consumption of resulting instance of the application.

The consumption model, the state model, the code-power analysis output, or a combination thereof can be used in a consumer environment for providing the application customized for a user. The consumer environment can include an identification portion for identifying the user and a user profile, a device profile, or a combination thereof associated with the user. The consumer environment can use a descriptive portion to communicate a consumption rating of the application specific to an average usage of the user according to the user profile, the device profile, or a combination thereof. The consumer environment can further generate the application customized to optimize the resource consumption according to the average usage using the code-power analysis output.

The consumption model provides improved efficiency in managing resources for the application. The code-power analysis output provides improved usability in optimizing the resource consumption through developing the application code and efficient resource management while reducing development burdens.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

The term “module” referred to herein can include or be implemented as software, hardware, or a combination thereof in the present invention in accordance with the context in which the term is used. For example, the software can be machine code, firmware, embedded code, and application software. The software can also include a function, a call to a function, a code block, or a combination thereof. Also for example, the hardware can be gates, circuitry, processor, computer, integrated circuit, integrated circuit cores, a pressure sensor, an inertial sensor, a microelectromechanical system (MEMS), passive devices, physical non-transitory memory medium having instructions for performing the software function, a portion therein, or a combination thereof.

The term “processing” as used herein includes filtering signals, decoding symbols, assembling data structures, transferring data structures, manipulating data structures, and reading and writing data structures. Data structures are defined to be information arranged as symbols, packets, blocks, files, input data, system generated data, such as calculated or generated data, and program data.

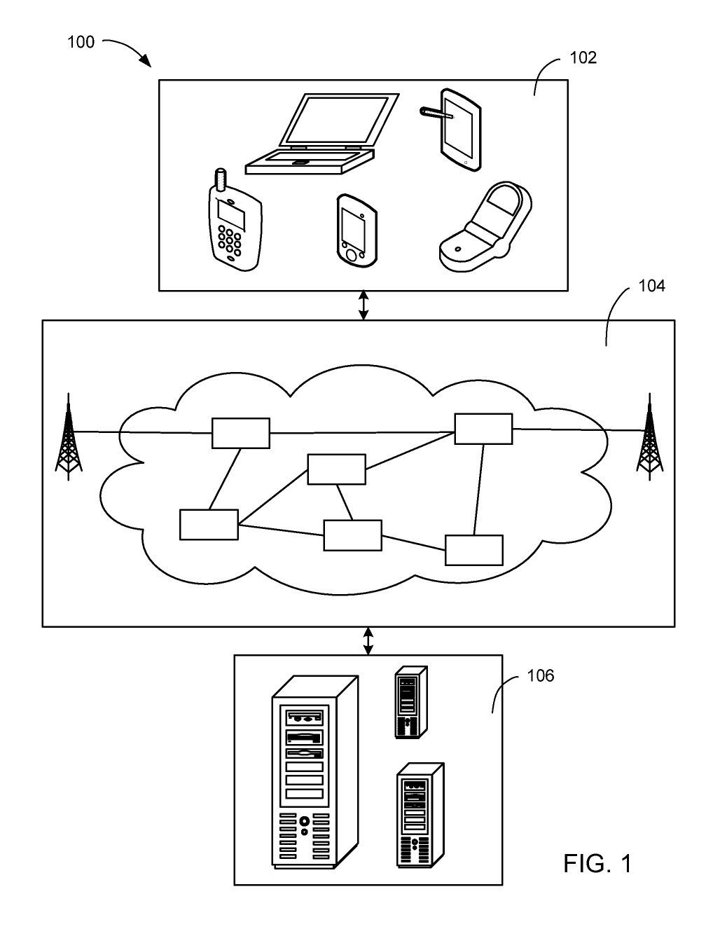

Referring now to FIG. 1, therein is shown a computing system 100 with power management mechanism in an embodiment of the present invention. The computing system 100 includes a first device 102, such as a mobile device including a cellular phone or a notebook computer, connected to a network 104.

The first device 102 can be a client or a server. For example, the first device 102 can be of any of a variety of devices, such as a smartphone, a cellular phone, personal digital assistant, a tablet computer, a notebook computer, or other multi-functional display or entertainment device. The first device 102 can couple, either directly or indirectly, to the network 104 for exchanging information with other devices.

The network 104 is a system of wired or wireless communication devices that are connected to each other for enabling communication between devices. For example, the network 104 can include a combination of wires, transmitters, receivers, antennas, towers, stations, repeaters, telephone network, servers, or client devices for a wireless cellular network. The network 104 can also include a combination of routers, cables, computers, servers, and client devices for various sized area networks.

The network 104 can span and represent a variety of network types and network topologies. For example, the network 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the network 104. Ethernet, digital subscriber line (DSL), fiber to the home (FTTH), and plain old telephone service (POTS) are examples of wired communication that can be included in the network 104. Further, the network 104 can traverse a number of network topologies and distances. For example, the network 104 can include direct connection, personal area network (PAN), local area network (LAN), metropolitan area network (MAN), wide area network (WAN), or a combination thereof.

Device users (not shown) can communicate with each other or access or create information using devices including text, images, symbols, location information, and audio, as examples. The users can be individuals or enterprise companies. The information can be created directly from a user or operations performed on these information to create more or different information.

The computing system 100 can include a second device 106 for directly or indirectly linking and communicating with the first device 102. The second device 106 can link or communicate with the first device 102 through the network 104. The second device 106 can receive wireless signals from the first device 102, transmit signals to the first device 102, process signals, or a combination thereof. The second device 106 can also relay signals between other base stations, components within the network 104, or a combination thereof.

The second device 106 can be any of a variety of centralized or decentralized computing devices. For example, the second device 106 can be a multimedia computer, a laptop computer, a desktop computer, a testing unit, a video game console, grid-computing resources, a virtualized computer resource, cloud computing resource, routers, switches, peer-to-peer distributed computing devices, a media playback device, a recording device, such as a camera or video camera, or a combination thereof. In another example, the second device 106 can be a server at a service provider or a computing device at a transmission facility.

The first device 102, the second device 106, or a combination thereof can connect to and communicate with other devices, such as other mobile devices, servers, computers, telephones, or a combination thereof. For example, the first device 102, the second device 106, or a combination thereof can communicate with other devices by transmitting signals, receiving signals, processing signals, or a combination thereof and displaying a content of the signals, audibly recreating sounds according to the content of the signals, processing according to the content, such as storing an application or updating an operating system, or a combination thereof.

For illustrative purposes, the computing system 100 is described with the first device 102 as a portable multi-functional consumer device, although it is understood that the first device 102 can be different types of devices. For example, the first device 102 can also be a workstation or a multi-media presentation, such as be a presentation including sound, a sequence of streaming images or a video feed, text or a combination thereof.

For further illustrative purposes, the computing system 100 is described with the second device 106 as a computing test device and as a server, although it is understood that the second device 106 can be different types of devices as described above. Also for illustrative purposes, the computing system 100 is shown with the second device 106 and the first device 102 as end points of the network 104, although it is understood that the computing system 100 can have a different partition between the first device 102, the second device 106, and the network 104. For example, the first device 102, the second device 106, or a combination thereof can also function as part of the network 104.

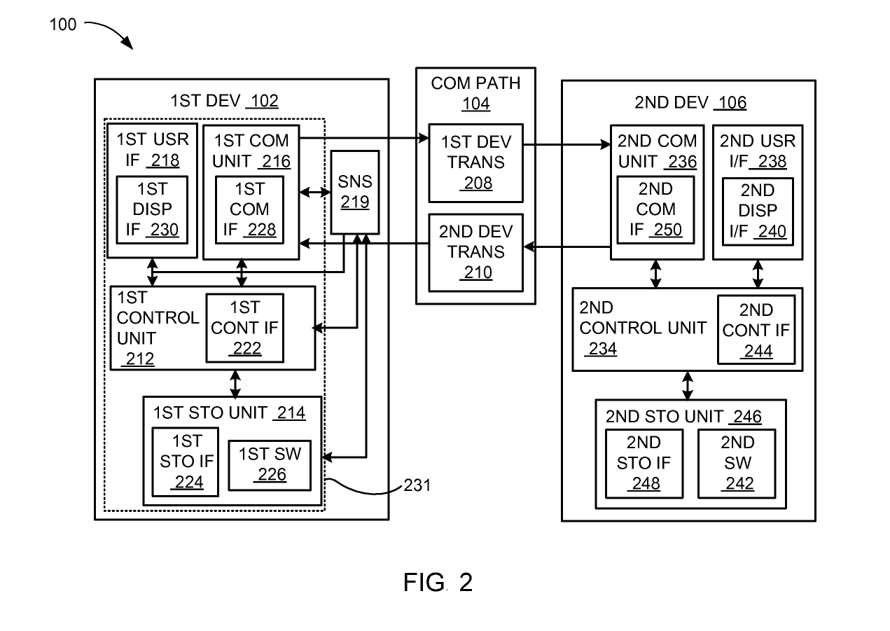

Referring now to FIG. 2, therein is shown an exemplary block diagram of the computing system 100. The computing system 100 can include the first device 102, the communication path 104, and the second device 106. The first device 102 can send information in a first device transmission 208 over the communication path 104 to the second device 106. The second device 106 can send information in a second device transmission 210 over the communication path 104 to the first device 102.

For illustrative purposes, the computing system 100 is shown with the first device 102 as a client device, although it is understood that the computing system 100 can have the first device 102 as a different type of device. For example, the first device 102 can be a server having a display interface.

Also for illustrative purposes, the computing system 100 is shown with the second device 106 as a server, although it is understood that the computing system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of an embodiment of the present invention.

The first device 102 can include a first control unit 212, a first storage unit 214, a first communication unit 216, a first user interface 218, a sensor 219, or a combination thereof. The first control unit 212 can include a first control interface 222. The first control unit 212 can execute a first software 226 to provide the intelligence of the computing system 100.

The first control unit 212 can be implemented in a number of different manners. For example, the first control unit 212 can be a processor, an application specific integrated circuit (ASIC) an embedded processor, a microprocessor, a hardware control logic, a hardware finite state machine (FSM), a digital signal processor (DSP), or a combination thereof. The first control interface 222 can be used for communication between the first control unit 212 and other functional units in the first device 102. The first control interface 222 can also be used for communication that is external to the first device 102.

The first control interface 222 can receive information from the other functional units or from external sources, or can transmit information to the other functional units or to external destinations. The external sources and the external destinations refer to sources and destinations external to the first device 102.

The first control interface 222 can be implemented in different ways and can include different implementations depending on which functional units or external units are being interfaced with the first control interface 222. For example, the first control interface 222 can be implemented with a pressure sensor, an inertial sensor, a microelectromechanical system (MEMS), optical circuitry, waveguides, wireless circuitry, wireline circuitry, or a combination thereof.

The first storage unit 214 can store the first software 226. The first storage unit 214 can also store the relevant information, such as data representing incoming images, data representing previously presented images, sound files, or a combination thereof.

The first storage unit 214 can be a volatile memory, a nonvolatile memory, an internal memory, an external memory, or a combination thereof. For example, the first storage unit 214 can be a nonvolatile storage such as non-volatile random access memory (NVRAM), Flash memory, disk storage, or a volatile storage such as static random access memory (SRAM).

The first storage unit 214 can include a first storage interface 224. The first storage interface 224 can be used for communication between the first storage unit 214 and other functional units in the first device 102. The first storage interface 224 can also be used for communication that is external to the first device 102.

The first storage interface 224 can receive information from the other functional units or from external sources, or can transmit information to the other functional units or to external destinations. The external sources and the external destinations refer to sources and destinations external to the first device 102.

The first storage interface 224 can include different implementations depending on which functional units or external units are being interfaced with the first storage unit 214. The first storage interface 224 can be implemented with technologies and techniques similar to the implementation of the first control interface 222.

The first communication unit 216 can enable external communication to and from the first device 102. For example, the first communication unit 216 can permit the first device 102 to communicate with the second device 106, a different device, an attachment, such as a peripheral device or a desktop computer, the communication path 104, or a combination thereof.

The first communication unit 216 can also function as a communication hub allowing the first device 102 to function as part of the communication path 104 and not limited to be an end point or terminal unit to the communication path 104. The first communication unit 216 can include active and passive components, such as microelectronics or an antenna, for interaction with the communication path 104.

The first communication unit 216 can include a baseband device or component, a modem, a digital signal processor, or a combination thereof for transmitting, formatting, receiving, detecting, decoding, further processing, or a combination thereof for communication signals. The first communication unit 216 can include one or more portions for processing the voltages, the currents, the digital information, or a combination thereof, such as an analog-to-digital converter, a digital-to-analog converter, a filter, an amplifier, a processor-type circuitry, or a combination thereof. The first communication unit 216 can further include one or more portions for storing information, such as cache or RAM memory, registers, or a combination thereof.

The first communication unit 216 can include a first communication interface 228. The first communication interface 228 can be used for communication between the first communication unit 216 and other functional units in the first device 102. The first communication interface 228 can receive information from the other functional units or can transmit information to the other functional units.

The first communication interface 228 can include different implementations depending on which functional units are being interfaced with the first communication unit 216. The first communication interface 228 can be implemented with technologies and techniques similar to the implementation of the first control interface 222.

The first user interface 218 allows a user (not shown) to interface and interact with the first device 102. The first user interface 218 can include an input device and an output device. Examples of the input device of the first user interface 218 can include a keypad, a touchpad, touchscreen, soft-keys, a keyboard, a microphone, an infrared sensor for receiving remote signals, any other similar input mechanisms, or any combination thereof to provide data and communication inputs.

The first user interface 218 can include a first display interface 230. The first display interface 230 can include an output device. The first display interface 230 can include a display, a projector, a video screen, a speaker, or any combination thereof.

The first control unit 212 can operate the first user interface 218 to display information generated by the computing system 100. The first control unit 212 can also execute the first software 226 for the other functions of the computing system 100. The first control unit 212 can further execute the first software 226 for interaction with the communication path 104 via the first communication unit 216.

The first control unit 212, the first storage unit 214, the first communication unit 216, the first user interface 218, or portions therein can be considered components 231 of the first device 102. The computing system 100 can include one or more of the components 231 coupled to the sensor 219. The sensor 219 can be a device or a portion of a device for observing operations or characteristics of the first device 102. The sensor 219 can also be a device or a portion of a device for observing application programming interface (API) commands, observing kernel events, measuring power or current utilized by one or more of the components 231 or a device overall, such as the first device 102.

The sensor 219 can be implemented in many ways and can include different implementations for interaction based on the components 231 interfaced therewith. For example, the sensor 219 can be implemented with an ammeter, a voltmeter, a power meter, a tester, or a combination thereof. As an additional example, the sensor 219 can be coupled, directly or indirectly, to the power supply rails of the components 231. Also for example, the sensor 219 can include an antenna, a lead, a probe, an inline resistor, or a combination thereof.

For illustrative purposes, the sensor 219 is shown as a singular unit. However, it is understood that the sensor 219 can include multiple sensors or multiple independent devices, such as sense resistors, inductors, or a combination thereof. For example, multiple instances of the sensor 219 can be coupled, directly or indirectly, to the various power supply rails of the components 231.

Also, for illustrative purposes, the sensor 219 is shown as being embedded in the first device 102. However it is understood that the sensor 219 can operate on the periphery or outside of the first device 102. For example, the sensor 219 can be a multi-meter coupled to the first device 102 to measure a current or voltage of one of the components 231 of the first device 102. Also for example, the sensor 219 can be included in the second device 106 operating as a testing station.

The sensor 219 can communicate the results of the measurement to the first control unit 212 or to another device through the first communication unit 216. For example, the sensor 219 can communicate the results of the measurement to the second device 106 through the communication path 104. The communication path 104 can also be a direct link between the first device 102 and the second device 106 or can include repeaters, amplifiers, or a combination thereof.

The second device 106 can be optimized for implementing an embodiment of the present invention in a multiple device embodiment with the first device 102. The second device 106 can provide additional or higher performance processing power compared to the first device 102. The second device 106 can include a second control unit 234, a second communication unit 236, a second user interface 238, and a second storage unit 246.

The second user interface 238 allows a user (not shown) to interface and interact with the second device 106. The second user interface 238 can include an input device and an output device. Examples of the input device of the second user interface 238 can include a keypad, a touchpad, a touchscreen, soft-keys, a keyboard, a microphone, or any combination thereof to provide data and communication inputs. Examples of the output device of the second user interface 238 can include a second display interface 240. The second display interface 240 can include a display, a projector, a video screen, a speaker, or any combination thereof.

The second control unit 234 can execute a second software 242 to provide the intelligence of the second device 106 of the computing system 100. The second software 242 can operate in conjunction with the first software 226. The second control unit 234 can provide additional performance compared to the first control unit 212.

The second control unit 234 can operate the second user interface 238 to display information. The second control unit 234 can also execute the second software 242 for the other functions of the computing system 100, including operating the second communication unit 236 to communicate with the first device 102 over the communication path 104.

The second control unit 234 can be implemented in a number of different manners. For example, the second control unit 234 can be a processor, an embedded processor, a microprocessor, hardware control logic, a hardware finite state machine (FSM), a digital signal processor (DSP), or a combination thereof.

The second control unit 234 can include a second control interface 244. The second control interface 244 can be used for communication between the second control unit 234 and other functional units in the second device 106. The second control interface 244 can also be used for communication that is external to the second device 106.

The second control interface 244 can receive information from the other functional units or from external sources, or can transmit information to the other functional units or to external destinations. The external sources and the external destinations refer to sources and destinations external to the second device 106.

The second control interface 244 can be implemented in different ways and can include different implementations depending on which functional units or external units are being interfaced with the second control interface 244. For example, the second control interface 244 can be implemented with a pressure sensor, an inertial sensor, a microelectromechanical system (MEMS), optical circuitry, waveguides, wireless circuitry, wireline circuitry, or a combination thereof.

A second storage unit 246 can store the second software 242. The second storage unit 246 can also store the information such as data representing incoming images, data representing previously presented image, sound files, or a combination thereof. The second storage unit 246 can be sized to provide the additional storage capacity to supplement the first storage unit 214.

For illustrative purposes, the second storage unit 246 is shown as a single element, although it is understood that the second storage unit 246 can be a distribution of storage elements. Also for illustrative purposes, the computing system 100 is shown with the second storage unit 246 as a single hierarchy storage system, although it is understood that the computing system 100 can have the second storage unit 246 in a different configuration. For example, the second storage unit 246 can be formed with different storage technologies forming a memory hierarchal system including different levels of caching, main memory, rotating media, or off-line storage.

The second storage unit 246 can be a volatile memory, a nonvolatile memory, an internal memory, an external memory, or a combination thereof. For example, the second storage unit 246 can be a nonvolatile storage such as non-volatile random access memory (NVRAM), Flash memory, disk storage, or a volatile storage such as static random access memory (SRAM).

The second storage unit 246 can include a second storage interface 248. The second storage interface 248 can be used for communication between the second storage unit 246 and other functional units in the second device 106. The second storage interface 248 can also be used for communication that is external to the second device 106.

The second storage interface 248 can receive information from the other functional units or from external sources, or can transmit information to the other functional units or to external destinations. The external sources and the external destinations refer to sources and destinations external to the second device 106.

The second storage interface 248 can include different implementations depending on which functional units or external units are being interfaced with the second storage unit 246. The second storage interface 248 can be implemented with technologies and techniques similar to the implementation of the second control interface 244.

The second communication unit 236 can enable external communication to and from the second device 106. For example, the second communication unit 236 can permit the second device 106 to communicate with the first device 102 over the communication path 104.

The second communication unit 236 can also function as a communication hub allowing the second device 106 to function as part of the communication path 104 and not limited to be an end point or terminal unit to the communication path 104. The second communication unit 236 can include active and passive components, such as microelectronics or resistors, for interaction with the communication path 104.

The second communication unit 236 can include a baseband device or component, a modem, a digital signal processor, or a combination thereof for transmitting, formatting, receiving, detecting, decoding, further processing, or a combination thereof for communication signals. The second communication unit 236 can include one or more portions for processing the voltages, the currents, the digital information, or a combination thereof, such as an analog-to-digital converter, a digital-to-analog converter, a filter, an amplifier, a processor-type circuitry, or a combination thereof. The second communication unit 236 can further include one or more portions for storing information, such as cache or RAM memory, registers, or a combination thereof.

The second communication unit 236 can include a second communication interface 250. The second communication interface 250 can be used for communication between the second communication unit 236 and other functional units in the second device 106. The second communication interface 250 can receive information from the other functional units or can transmit information to the other functional units.

The second communication interface 250 can include different implementations depending on which functional units are being interfaced with the second communication unit 236. The second communication interface 250 can be implemented with technologies and techniques similar to the implementation of the second control interface 244.

The first communication unit 216 can couple with the communication path 104 to send information to the second device 106 in the first device transmission 208. The second device 106 can receive information in the second communication unit 236 from the first device transmission 208 of the communication path 104.

The second communication unit 236 can couple with the communication path 104 to send information to the first device 102 in the second device transmission 210. The first device 102 can receive information in the first communication unit 216 from the second device transmission 210 of the communication path 104. The computing system 100 can be executed by the first control unit 212, the second control unit 234, or a combination thereof. For illustrative purposes, the second device 106 is shown with the partition having the second user interface 238, the second storage unit 246, the second control unit 234, and the second communication unit 236, although it is understood that the second device 106 can have a different partition. For example, the second software 242 can be partitioned differently such that some or all of its function can be in the second control unit 234 and the second communication unit 236. Also, the second device 106 can include other functional units not shown in FIG. 2 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

The functional units described above can be implemented in hardware. For example, one or more of the functional units can be implemented using the a gate, circuitry, a processor, a computer, integrated circuit, integrated circuit cores, a pressure sensor, an inertial sensor, a microelectromechanical system (MEMS), a passive device, a physical non-transitory memory medium having instructions for performing the software function, a portion therein, or a combination thereof.

For illustrative purposes, the computing system 100 is described by operation of the first device 102 and the second device 106. It is understood that the first device 102 and the second device 106 can operate any of the modules and functions of the computing system 100.

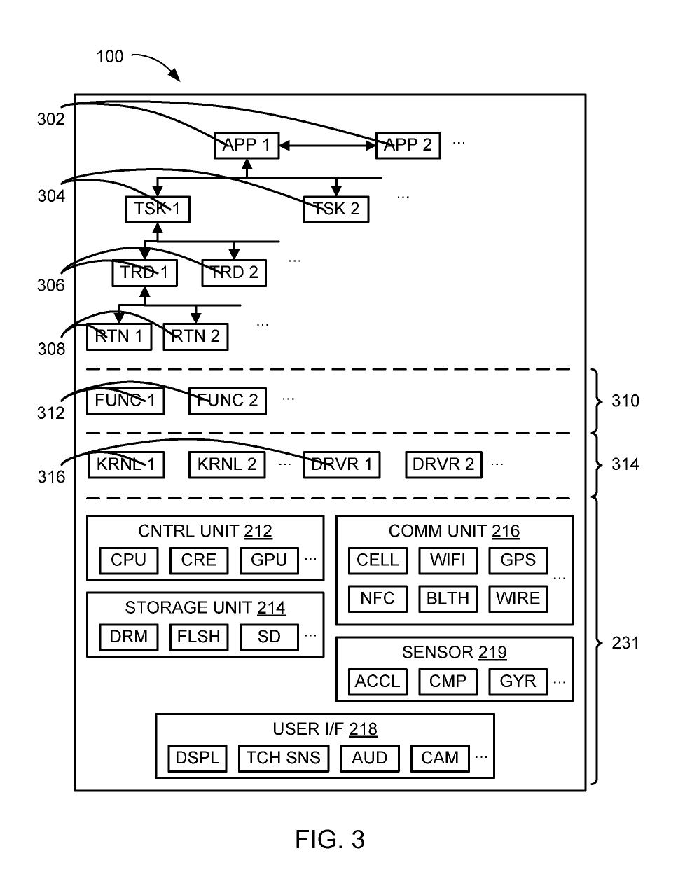

Referring now to FIG. 3, therein is shown a further example block diagram of the computing system 100. The computing system 100 can include one more instances of an application 302 in an application layer, for implementing the application 302 through the first device 102 of FIG. 1, the second device 106 FIG. 1, or a combination thereof. The application 302 can include an executable unit of software or program causing the computing system 100 to perform an action or achieve a goal beyond running the computing system 100. For example, the application 302 can include an execution file.

The application 302 can include or implement one or more instances of a task 304. The task 304 is a high level grouping or distinction of a set of instructions for achieving or performing a specific instance of the action or the goal. The task 304 can include a function or a feature available through corresponding instance of the application 302. The task 304 can include or implement one or more instances of a thread 306. The thread 306 can include an execution of programmed instructions that can be managed independently.

The thread 306 can further include or implement one or more instances of a routine 308. The routine 308 is a sequence of program instructions performing a specific instance of the task 304, packaged as a unit. The routine 308 can be used in other instances of the application 302 or programs wherever the particular instance of the task 304 is necessary or desired. The routine 308 can include a subroutine (not shown).

The computing system 100 can include a framework portion 310 for implementing the application 302. The framework portion 310 is an abstraction for creating or modifying the application 302. The framework portion 310 can include a development platform, products, tools, or a combination thereof. For example, the framework portion 310 can include compilers, libraries, debugger, the API, or a combination thereof.

The framework portion 310 can include one or more instances of a framework function 312. The framework function 312 is a process or a set of instructions for implementing a part of the framework portion 310 or the features and functions therein. The framework function 312 can include the data or instructions for implementing or accessing the compilers, the libraries, the debugger, the API, or a combination thereof.

The computing system 100 can further include an implementation portion 314 for implementing the application 302. The implementation portion 314 can include an operating system, an environment for the application 302, a mechanism for interacting or instructing hardware components, or a combination thereof. For example, the implementation portion 314 can further include an implementation mechanism 316 for interacting or instructing hardware components, such as kernels, schedulers, drivers, firmware or middleware, or a combination thereof.

The implementation portion 314 can be for controlling or executing the components 231. For example, the implementation portion 314 can control or execute the control unit 212, such as a central processing unit (CPU), a core, a graphics processing unit (GPU), or a combination thereof. Also for example, the implementation portion 314 can control or execute the storage unit 214. Also for example, the implementation portion 314 can control or execute the communication unit 216, the sensor 219, the user interface 218, or a combination thereof.

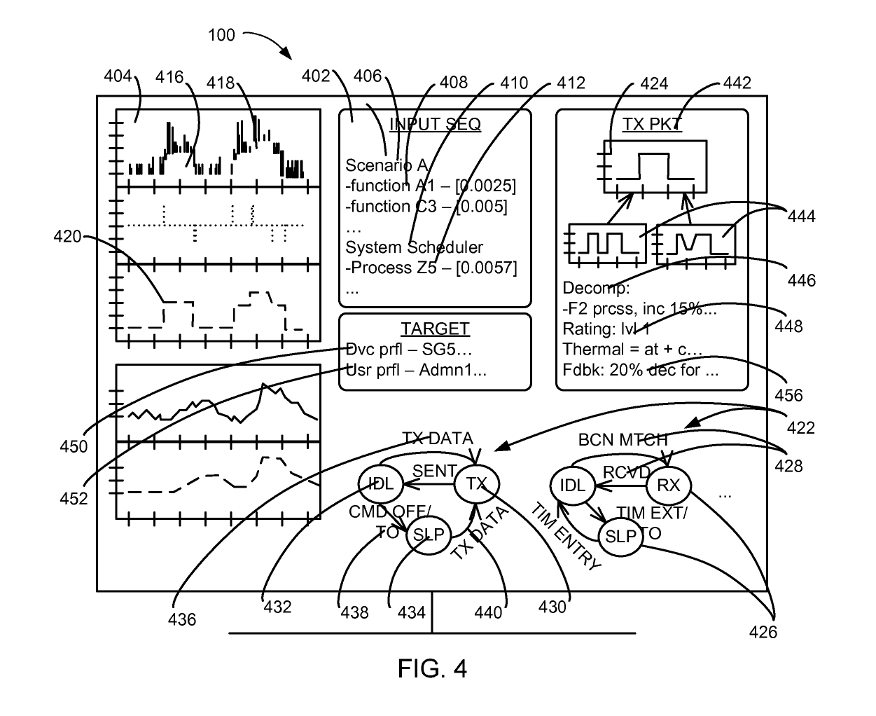

Referring now to FIG. 4, therein is shown an example display of the computing system 100. The computing system 100 can show exemplary data on the display. For example, the computing system 100 can show an input sequence 402, a consumption measurement 404, or a combination thereof.

The input sequence 402 can be one or more instances of stimulus for the first device 102 of FIG. 1, the second device 106 of FIG. 1, or a combination thereof. The input sequence 402 can include a command, a trigger, a time-out, an input signal or value, a change in status, or a combination thereof affecting a process or a state of the first device 102, the second device 106, or a combination thereof.

For example, the input sequence 402 can include a usage scenario 406 including an application call 408, a system scheduler 410 including a system call 412, or a combination thereof. The usage scenario 406 can be one or more inputs originated through or by the application 302 of FIG. 3. The application call 408 can be the individual instance of the input originated through or by the application 302. The application call 408 can be based on the task 304 of FIG. 3, the thread 306 of FIG. 3, the routine 308 of FIG. 3, or a combination thereof.

The system scheduler 410 can be one or more inputs originated through or by a source outside of the application 302. The system scheduler 410 can be originated through or by the implementation portion 314 of FIG. 3 (such as an operating system or firmware programming), the framework portion 310 of FIG. 3, a different instance of the application 302, or a combination thereof. The system call 412 can be the individual instance of the input originated through or by the source outside the designated instance of the application 302.

The input sequence 402 can further include other information regarding the application 302, the components 231 of FIG. 2, the first device 102, the second device 106, a portion therein, or a combination thereof. For example, the input sequence 402 can include a state diagram or table, a specification sheet or table, a manufacturing standard, a previously existing model or profile, or a combination thereof for software, hardware, firmware or middleware, or a combination thereof associated with the computing system 100. The input sequence 402 can be data provided by the computing system 100, the manufacturer, a designer, a tester, a user, or a combination thereof.

The consumption measurement 404 is a representation of an amount of resources used by the application 302. The consumption measurement 404 can represent the amount of energy, such as power or current, processing power or bandwidth, time or duration, or a combination thereof used by the first device 102, the second device 106, or a combination thereof for executing the application 302.

The consumption measurement 404 can be based on the input sequence 402. The consumption measurement 404 can include a measurement directly in response to the input sequence 402. The consumption measurement 404 can include an estimate in response to available or provided data.

The consumption measurement 404 can include a record of one or more resources used, timing or duration associated therewith, a corresponding event or input, or a combination thereof. For example, the consumption measurement 404 can include a table or a graph.

For illustrative purposes, the consumption measurement 404 will be described as a graph having current represented along a vertical axis and time represented along a horizontal axis. However, it is understood that the consumption measurement 404 can be different as described above. For example, the consumption measurement 404 can include a table. Also for example, the consumption measurement 404 can include a representation of power or energy in watts or joules, bandwidth or processing cycle consumed, or a combination thereof.

The computing system 100 can include an analysis environment for measuring and determining resource usage or consumption of the application 302. The computing system 100 can include the analysis environment specific for the application 302, the first device 102, the second device 106, the framework portion 310, the implementation portion 314, a specific portion therein, or a specific combination thereof.

The computing system 100 can include the analysis environment for issuing or executing the input sequence 402, capturing a corresponding response as the consumption measurement 404, modeling the resource behavior, or a combination thereof. For example, the second device 106 can issue or execute the input sequence 402 by providing input or manipulating interaction or environment for the first device 102. The consumption levels on the first device 102 can be monitored and captured by the second device 106 through the sensors 219.

The computing system 100 can analyze the consumption measurement 404 based on the input sequence 402. The computing system 100 can determine an input-corresponding portion 416, an overlap portion 418, a fitting estimation 420, or a combination thereof using the consumption measurement 404.

The input-corresponding portion 416 is a portion of the consumption measurement 404 that directly corresponds to a stimulus. The input-corresponding portion 416 can include a portion of the consumption measurement 404 directly corresponding to a portion of the input sequence 402. For example, the input-corresponding portion 416 can be represented as an increased or decreased level in resource consumption, a change in the amount of resource consumption, or a combination thereof.

The input-corresponding portion 416 can be a detected level of resource consumption rising above a noise level, sustaining over a prolonged duration, or a combination thereof. The computing system 100 can determine the input-corresponding portion 416 based on variety of factors, such on threshold, average value, patterns, or a combination thereof. Details regarding the determination of the input-corresponding portion 416 will be described below.

The overlap portion 418 is a portion of the consumption measurement 404 that directly corresponds to more than one stimulus. The overlap portion 418 can be based on simultaneous multiple input stimuli. The overlap portion 418 can further be based on a sequence of stimuli having response duration longer than a stimulus gap.

The fitting estimation 420 is a derived result estimating a value or a pattern associated with the consumption measurement 404. The fitting estimation 420 can be an estimate on the level of consumption or reactions, a derivative or a rate of change thereof, a pattern thereof, or a combination thereof. The fitting estimation 420 can be based on a set of waves having different frequencies, average values, thresholds, filtering, derivatives, pattern analysis, machine learning, or a combination thereof. Details regarding the fitting estimation 420 will be described below.

The computing system 100 can determine a state model 422, a consumption model 424, or a combination thereof. The computing system 100 can determine the state model 422, the consumption model 424, or a combination thereof based on the consumption measurement 404, the input sequence 402, the input-corresponding portion 416, the overlap portion 418, the fitting estimation 420, or a combination thereof.

The state model 422 is a derived result representing a mathematical model of computation for designing a computer system. The state model 422 can represent an abstraction of hardware, software, or a combination thereof, such as the application 302, the components 231 of FIG. 2, the computing system 100, a portion therein, or a combination thereof. The state model 422 can include a finite-state machine. The state model 422 can be an estimation or a processing result produced by the computing system 100 and can be different from state related data included in the input sequence 402.

The state model 422 can include various formats. For example, the state model 422 can include a diagram, a table, a list, or a combination thereof. Also for example, the state model 422 can include a function state 426 and a change condition 428.

The function state 426 can be a mode or a condition describing the application 302, the components 231, a portion therein, or a combination thereof. The function state 426 can describe a progress for a process, a configuration or a setting, a value, or a combination thereof.

For example, the function state 426 can include a communication state 430, an idle state 432, a sleep state 434, or a combination thereof. The communication state 430 can include the mode or the condition including the first communication unit 216 of FIG. 2, the second communication unit 236 of FIG. 2, or a combination thereof actively transmitting or receiving information.

The idle state 432 can include the mode or the condition including the first communication unit 216, the second communication unit 236, or a combination thereof waiting to transmit or receive information, such as waiting for a response or a timing. The sleep state 434 can include the mode or the condition including the first communication unit 216, the second communication unit 236, or a combination thereof being inactive without any known expectations of later-occurring communication. The sleep state 434 can include the components 231 not listening and not ready to transmit.

The change condition 428 can be circumstances or factors that can change the function state 426. The change condition 428 can be represented as an arrow pointing from one instance of the function state 426 to a different instance of the function state 426 in a diagram. The change condition 428 can also be represented as a table entry, a set of values, a rule, or a combination thereof.

The change condition 428 can include a condition trigger 436, a residency time 438, a next-state 440, or a combination thereof. The condition trigger 436 can include factors, inputs, results, intermediate values, conditions, rules, or a combination thereof necessary for changing from a specific state to a different state. The residency time 438 can include a temporal duration for remaining in one the specific state before changing to the different state. The residency time 438 can be a temporal instance of the condition trigger 436. The next-state 440 can include the different state as a target of the transition from the specific state based on meeting the condition trigger 436.

For example, the first communication unit 216, the second communication unit 236, or a combination thereof can include a specific instance of the task 304 or the thread 306 as the condition trigger 436 for transitioning from the communication state 430 to the next-state 440 of the idle state 432. Also for example, the first communication unit 216, the second communication unit 236, or a combination thereof can include a duration predetermined by the computing system 100 or the application 302 as the residency time 438 for remaining in the idle state 432 or a different command before transitioning to the sleep state 434.

The consumption model 424 is a representation of behavior or characteristic regarding energy consumption associated with the application 302, the first device 102, the second device 106, or a combination thereof. The consumption model 424 can be a representation or estimation for an amount of consumption, a pattern of consumption, a timing for the consumption, or a combination thereof specific to the application 302, the first device 102, the second device 106, a portion therein, or a combination thereof.

For example, the consumption model 424 can include a function-specific consumption 442, a combined-state consumption 444, a state-decomposition consumption 446, a consumption rating 448, or a combination thereof. The function-specific consumption 442 is a representation of behavior or characteristic regarding energy consumption associated with a specific action or feature of the application 302.

The function-specific consumption 442 can be specific to one or an associated grouping of the task 304, the thread 306, the routine 308, or a combination thereof. The function-specific consumption 442 can be specific to one or the associated grouping for a specific instance or a specific combination of the application 302, the implementation portion 314, the first device 102, or the second device 106.

For example, the function-specific consumption 442 can represent an amount consumption, a pattern of consumption, a timing for the consumption, or a combination thereof specific to transmitting a standardized packet or for actively receiving wireless message. The function-specific consumption 442 can be for transmitting or receiving for a specific instance of the application 302, at a specific location within the application 302, for a specific instance of the implementation mechanism 316 of FIG. 3, for a specific instance of the components 231, for a specific instance of the first device 102, for a specific instance of the second device 106, or a combination thereof.

The combined-state consumption 444 is a single representation covering a number of variations in energy consumption associated with the specific action or feature of the application 302. For example, the combined-state consumption 444 can eliminate delays, gaps, varying sequence, or a combination thereof in executing the specific action or feature. The combined-state consumption 444 can include a generalized or averaged result of energy consumption over possible variations in consumption associated with the specific action or feature.

The combined-state consumption 444 can further represent multiple states, such as a first state and a second state. The combined-state consumption 444 can represent multiple states when the multiple states are similar based on characteristics, such as overall duration, consumption level, consumption pattern, or a combination thereof. The combined-state consumption 444 can be further based on eliminating a consumption gap satisfying a gap threshold predetermined by the computing system 100.

The state-decomposition consumption 446 is an adjustment to a consumption level based on concurrent occurrence of multiple states. The state-decomposition consumption 446 can include a rule, a case, an equation, an exception, or a combination thereof for instances when concurrent occurrence of multiple states do not result in additive result for the corresponding instances of the function-specific consumption 442.

For example, when a specific instance of the application call 408 and a specific instance of the system call 412 occur concurrently, the components 231 can consume an amount of energy greater or lesser than the combination of the function-specific consumption 442 corresponding to the system call 412 and the application call 408. Also for example, the actual consumption for concurrent processes can consume over a pattern different from the function-specific consumption 442 of each or combination of the functions. The state-decomposition consumption 446 can include an adjustment accounting for the differences in the specific combinations of functions or processes.

The computing system 100 can analyze consumption data for the application 302 to calculate the combined-state consumption 444, to generate the state-decomposition consumption 446, or a combination thereof. Details regarding the combined-state consumption 444 and the state-decomposition consumption 446 will be described below.

The consumption rating 448 is an overall representation of energy consumption for the application 302. The consumption rating 448 can include a score, a level, an abstract representation, or a combination thereof classifying or representing an amount of consumption. For example, the consumption rating 448 can be represented as a rating utilizing a number of stars. The consumption rating 448 can be specific to a device, a component, an instance of the application 302, a user, or a combination thereof. For example, the consumption rating 448 can be specific for the components 231, a device profile 450, a user profile 452, the application 302, the implementation portion 314, or a combination thereof.

The device profile 450 can include a description of the device running the application 302, such as the first device 102, the second device 106, or a combination thereof. For example, the device profile 450 can include a description of the components 231, such as a serial number or a part classification, a description of the implementation mechanism 316, such as a version number or a driver name, a service provider identification, a registration information, other applications existing or running, settings, configurations, or a combination thereof associated with the device having the application 302 therein or intended for the application 302.

The user profile 452 can include a description of the user running the application 302 or intended to utilize the application 302. For example, the user profile 452 can include identification information, usage or access pattern or history, favorites, preferences, demographic information, trends, personal connections, or a combination thereof associated with the user using the application 302 or intending to use the application 302.

The computing system 100 can track or record data associated with the user, the first device 102, or a combination thereof for determining the user profile 452, the device profile 450, or a combination thereof. For example, the computing system 100 can track or record registration information, time and duration of usage, data communicated during usage, location information, accessed application or the functions therein, preference settings, configurations, or a combination thereof. The computing system 100 can process the tracked or recorded data to determine the user profile 452, the device profile 450, or a combination thereof.

The computing system 100 can generate the consumption rating 448 based on the device profile 450, the user profile 452, or a combination thereof. Details regarding the consumption rating 448 relative to the device profile 450 and the user profile 452 will be described below.

The computing system 100 can further use a historical user-feedback 456. The computing system 100 can use information from users to adjust and update the consumption model 424. For example, the computing system 100 can use the historical user-feedback 456 including user feedback, usage information, such as history or direct consumption data, or a combination thereof for the application 302.

The computing system 100 can process the state model 422, the consumption model 424, or a combination thereof based on the consumption measurement 404, the input sequence 402, or a combination thereof. The computing system 100 can further use the historical user-feedback 456 as an addition to the input sequence 402, the consumption measurement 404, or a combination thereof. Further details regarding the state model 422, and the consumption model 424 will be described below.

It has been discovered that the consumption model 424 provides improved efficiency in managing resources for the application 302. The consumption model 424 based on the state model 422 can simplify the various consumption patterns for one or a combination of the components 231 and accurately estimate the resource consumption amount and pattern.

It has further been discovered that the consumption model 424 based on the consumption measurement 404 provides accurate estimations of the power consumption. The consumption measurement 404 can be measured data in user environments that can enhance data available as the input sequence 402 in modeling the power consumption.

It has further been discovered that the consumption model 424 including the combined-state consumption 444 provides enhanced usability and reduces complexity for the computing system 100. The consumption model 424 including the combined-state consumption 444 can reduce the total number of states modeled and reduce the data necessary. Moreover, the consumption model 424 can combine numerous variants or conditions for a state, an action, or a process, further simplifying the number of states.

It has further been discovered that the consumption model 424 including the state-decomposition consumption 446 provides accurate estimations of the power consumption. The consumption model 424 including the state-decomposition consumption 446 can account for dynamic effects resulting from specific combinations of actions, processes, the components 231, or a combination thereof. The consumption model 424 including the state-decomposition consumption 446 can represent and adjust for exceptions, such as non-additive nature or behavior in power consumption for the specific combinations.

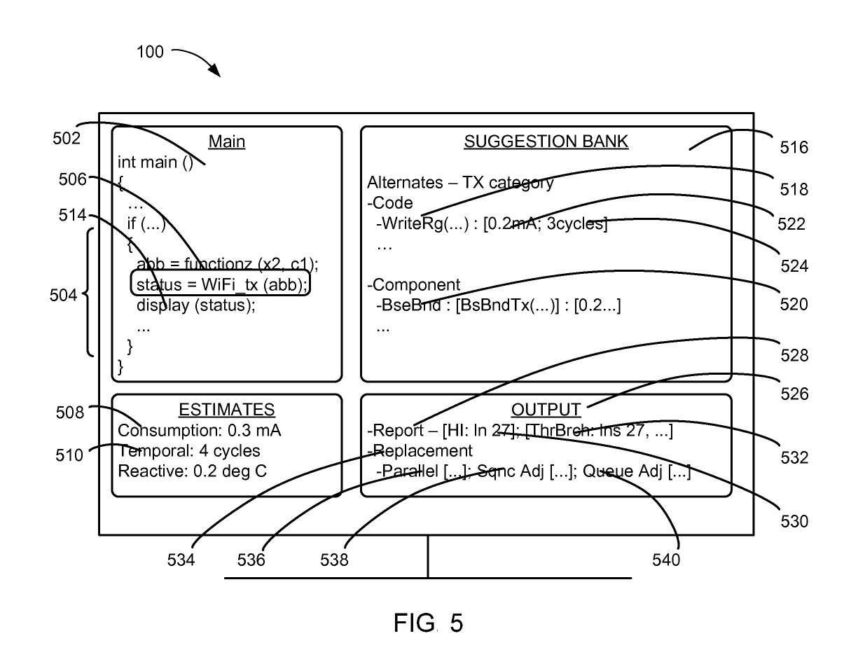

Referring now to FIG. 5, therein is shown a further example display of the computing system 100. The computing system 100 can show a development environment, such as for the framework portion 310 of FIG. 3, for developing the application 302 of FIG. 3. The development environment can be for generating the application 302 based on an application code 502. The development environment can further be for generating the application 302 optimizing the resource consumption.

The development environment can include the first device 102 of FIG. 1, the second device 106 of FIG. 1, or a combination thereof as a development platform. For example, the first device 102, the second device 106, or a combination thereof can include a station or a device interfacing with a developer, a central computer or a server supporting the interfacing station, or a combination thereof.

The application code 502 can include a series of instructions corresponding to instructions to be executed by a device or system. The application code 502 can include a source code. The application code 502 can be written in text using a user-readable computer language.

The application code 502 can correspond to instructions, operations, process, or a combination thereof intended for operation by the computing system 100, a device therein, such as the first device 102, the second device 106, or a combination thereof. The application code 502 can further correspond to one or more of the components 231 of FIG. 2 within one or more of the devices of the computing system 100.

The application code 502 can be used to produce or generate the application 302. The application code 502 can be compiled to machine-readable instructions representing the application 302.

The application code 502 can include a target section 504, a target code 506, or a combination thereof. The target section 504 is a grouping of instructions within the application code 502 as a subject of a process or an analysis. The target section 504 can include one instruction or a grouping of instructions including a common goal, leading up to a product or a result, involving a specific component, based on a specific theme, or a combination thereof.

The target code 506 is an instruction within the application code 502 as a subject of a process or an analysis. The target section 504 can include the target code 506 or can be associated with the target code 506.

For example, the target code 506 can be a single line of code and the target section 504 can include lines of code representing a function, a case, an evaluation, a sequence of calculations, or a combination thereof including the target code 506 therein. As a more specific example, the target code 506 can include lines of code within a grouping mechanism, such as using brackets, indentations, comments, “end of line” or “end of file” character, or a combination thereof including or encompassing the target code 506.

Also for example, the target code 506 can be a function call and the target section 504 can be a description or a definition including details or instructions for performing the function corresponding to the function call. Also for example, the target section 504 can include lines of code designed to execute immediately before, immediately after, concurrent with, in response to, as a cause of, or a combination thereof for the target code 506.

The computing system 100 can identify the target code 506, the target section 504, or a combination thereof for further processing. The computing system 100 can identify the target code 506, the target section 504, or a combination thereof through the framework portion 310. Details regarding the target selection will be described below.

The computing system 100 can represent or display results of the further processing associated with the target code 506, the target section 504, or a combination thereof through the framework portion 310. For example, the computing system 100 can communicate, such as by displaying numbers or generating a known sound, a consumption estimate 508, a temporal estimate 510, or a combination thereof.

The consumption estimate 508 is a calculated result approximating an amount of resources necessary for executing one or more instructions. The consumption estimate 508 can be for executing the target section 504, the target code 506, or a combination thereof. The consumption estimate 508 can be based on the consumption model 424 of FIG. 4.

The temporal estimate 510 is a calculated result approximating amount of time necessary for executing one or more instructions. The temporal estimate 510 can approximate multiple durations based on different consumption levels associated with executing one or more instructions. The consumption estimate 508 can include the temporal estimate 510.

The consumption estimate 508, the temporal estimate 510, or a combination thereof can be based on other instructions or other lines of code. For example, the consumption estimate 508, the temporal estimate 510, or a combination thereof can be based on a parallel process or execution, a dissipation pattern, a residual reaction or a remaining pattern, or a combination thereof associated with the other instructions or the other lines of code.

For example, the target section 504 can influence the consumption estimate 508, the temporal estimate 510, or a combination thereof for the target code 506. The target section 504 can provide a compounding effect for the target code 506. Also for example, the target code 506 can influence the target section 504.

Also for example, the target code 506 can affect the consumption estimate 508, the temporal estimate 510, or a combination thereof for a subsequent code 514 occurring or written below or after the target code 506. Also for example, the subsequent code 514 can similarly affect the target code 506.

The computing system 100 can update the consumption estimate 508, the temporal estimate 510, or a combination thereof for the target code 506, the target section 504, the subsequent code 514, or a combination thereof. The computing system 100 can update the consumption estimate 508, the temporal estimate 510, or a combination thereof based on updates to the target code 506, the target section 504, the subsequent code 514, or a combination thereof. The computing system 100 can update through the framework portion 310.

The computing system 100 can further utilize a suggestion bank 516. The suggestion bank 516 is one or a grouping of actions or choices intended to replace one or more lines of instructions or codes for the user.

The computing system 100 can provide the suggestion bank 516 based on the target code 506, the target section 504, the subsequent code 514, or a combination thereof. The suggestion bank 516 can further be based on the implementation portion 314 of FIG. 3, the device profile 450 of FIG. 4, the user profile 452 of FIG. 4, a portion therein, such as one or more of the components 231, or a combination thereof. The suggestion bank 516 can be grouped, organized, classified, associated or a combination thereof for actions or processes.

The suggestion bank 516 can include alternate instruction, a different organization, a different target or component for performing the action, or a combination thereof. For example, the suggestion bank 516 can include an alternate code 518, an alternate component 520, an alternate consumption 522, an alternate performance 524, or a combination thereof.

The alternate code 518 can include one or more instructions or code for performing the action or the process. The alternate code 518 can be used for providing one or more instructions or code different from the target code 506 for performing same or similar action as the target code 506. The alternate code 518 can further include different arrangements or sequence for replacing the target code 506, the target section 504, or a combination thereof.

The alternate component 520 can include one or more components for performing the action or the process. The alternate component 520 can be implemented through different set of commands or instructions, such as the alternate code 518. The alternate component 520 can be organized or grouped based on a component category, the function state 426 of FIG. 4, the action or the process, or a combination thereof.

The alternate component 520 can be used for providing one or more components different from the component intended or designated by the target code 506 for performing same or similar action as the target code 506. For example, the alternate component 520 can include using a global positioning system (GPS) receiver, a WiFi communication unit, a cellular communication unit, or a combination thereof for locating a device.

The alternate consumption 522 is a representation of resource usage associated with the alternate selection within the suggestion bank 516. The alternate consumption 522 can include a score, a rating, a quantity, a classification, or a combination thereof representing an estimated consumption of energy associated with each of the alternate code 518 or the alternate component 520 in the suggestion bank 516.

The alternate performance 524 is a representation of efficiency associated with the alternate selection within the suggestion bank 516. The alternate performance 524 can include a score, a rating, a quantity, a classification, or a combination thereof representing an estimated speed, clock cycles, delay, overall duration, or a combination thereof associated with utilizing each of the alternate code 518 or the alternate component 520 in the suggestion bank 516.

The computing system 100 can generate a code-power analysis output 526 through the framework portion 310. The code-power analysis output 526 is a processing result for optimizing resource consumption or a reaction for the application 302. For example, the code-power analysis output 526 can include suggestions or alternatives to optimizing the energy consumption or temperature buildup.

The code-power analysis output 526 can include a notice, a replacement code, a rearrangement, or a combination thereof regarding the target code 506, the target section 504, or a combination thereof. For example, the code-power analysis output 526 can include a consumption report 528. The consumption report 528 is a notice generated by the computing system 100 to communicate the resource consumption for the developer. The consumption report 528 can include a warning, an estimated quantity or magnitude, a categorization, or a combination thereof.

As a more specific example, the consumption report 528 can include a relative-highest section 530 or a threshold breach 532. The relative-highest section 530 can be a warning, an estimated quantity or magnitude, a categorization, or a combination thereof within a given portion of the application code 502 estimated to result in highest consumption of the resource or a maximum reaction. The threshold breach 532 can include a warning, an estimated quantity or magnitude, a categorization, or a combination thereof for any portion of the application code 502 exceeding a threshold predetermined by the computing system 100.

Also for example, the code-power analysis output 526 can include a replacement code 534. The replacement code 534 is one or a grouping of instructions or code for replacing developer-generated instruction or code to optimize the computing system 100. The replacement code 534 can include one or a grouping of instructions or code estimated to result in lower energy consumption or temperature level in comparison to the target code 506, the target section 504, or a combination thereof.

Continuing with the example, the replacement code 534 can be based on the consumption model 424, the suggestion bank 516, or a combination thereof. The replacement code 534 can use a different instance of the function state 426, the components 231, device, command, instruction, or a combination thereof.

The replacement code 534 can further include a parallel configuration 536, a sequential adjustment 538, a queue adjustment 540, or a combination thereof. The parallel configuration 536 is one or a grouping of instructions, settings, code, or a combination thereof for simultaneously executing multiple actions or processes. The parallel configuration 536 can include the instruction, the code, the setting, or a combination thereof for simultaneously utilizing multiple components, multiple devices, or a combination thereof.

The sequential adjustment 538 is reorganization for instructions or code for optimizing the application 302. The sequential adjustment 538 can be the target section 504 with different sequence for the instructions or the code therein. The sequential adjustment 538 can correspond to an improvement in the resource consumption or temperature level compared to the target section 504. The sequential adjustment 538 can be represented as relocation or a different location for the target code 506, a new instance of the target section 504 including the reorganization, or a combination thereof.

The queue adjustment 540 is one or a grouping of instructions, settings, code, or a combination thereof for combining actions or processes. The queue adjustment 540 can abstractly queue instructions or code being executed for the application 302. The queue adjustment 540 can be represented as a case or evaluation based instruction, the sequential adjustment 538, the parallel configuration 536, or a combination thereof. For example, the queue adjustment 540 can delay and combine messages intended for separate communications to optimize packet size, time slot, capabilities, or a combination thereof.

It has been discovered that the code-power analysis output 526 provides intelligent runtime adaptation for improving resource consumption. The code-power analysis output 526 based on the suggestion bank 516 provides various choices that can be adapted or utilized based on different conditions during runtime. The suggestion bank 516 and the code-power analysis output 526 provides tools and methods for analyzing and implementing for increased number of conditions or possibilities and the resulting resource consumption.

It has further been discovered that the suggestion bank 516 provides improved efficiency in developing the application code 502. The suggestion bank 516 can be used to provide coding or instructions matching abstract ideas, key words, or pseudo-code and reduce redundant coding, syntax or runtime errors, or a combination thereof.

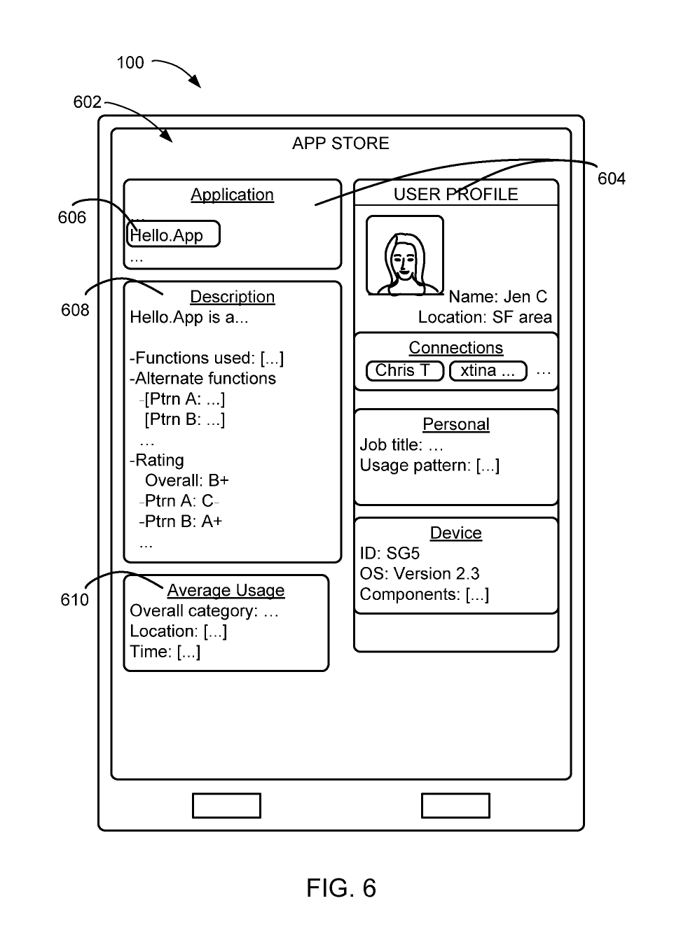

Referring now to FIG. 6, therein is shown an additional example display of the computing system 100. For example, the computing system 100 can show a consumer environment 602. The consumer environment 602 can include a surrounding and a mechanism for communicating a description regarding the application 302 of FIG. 3.

For example, the consumer environment 602 can include a digital or an online store, a user review, a blog entry, an article, a consumer report, or a combination thereof describing the application 302. The consumer environment 602 can further include a platform or a webpage for downloading the application 302 to or from the first device 102 of FIG. 1, the second device 106 of FIG. 1, or a combination thereof.

The consumer environment 602 can provide various descriptions for the application 302, user, device, or a combination thereof. For example, the consumer environment 602 can include an identification portion 604. The identification portion 604 is a section of an environment or a webpage dedicated to identification of key information. As a more specific example, the identification portion 604 can include an application identification 606, such as a name or a link, the device profile 450 of FIG. 4, the user profile 452 of FIG. 4, or a combination thereof.

Also for example, the consumer environment 602 can include a descriptive portion 608 for communicate resource consumption caused by the application 302. The descriptive portion 608 can further communicate other information, such as function, content, purpose, or a combination thereof.

As a more specific example, the descriptive portion 608 can include the consumption rating 448 of FIG. 4, an average usage 610 corresponding to common or frequent usage, purpose, duration, pattern, or a combination thereof specific for the user accessing the consumer environment 602. The computing system 100 can further communicate the consumption rating 448 personalized for the user accessing the consumer environment 602 based on the average usage 610, the user profile 452, the device profile 450, or a combination thereof.

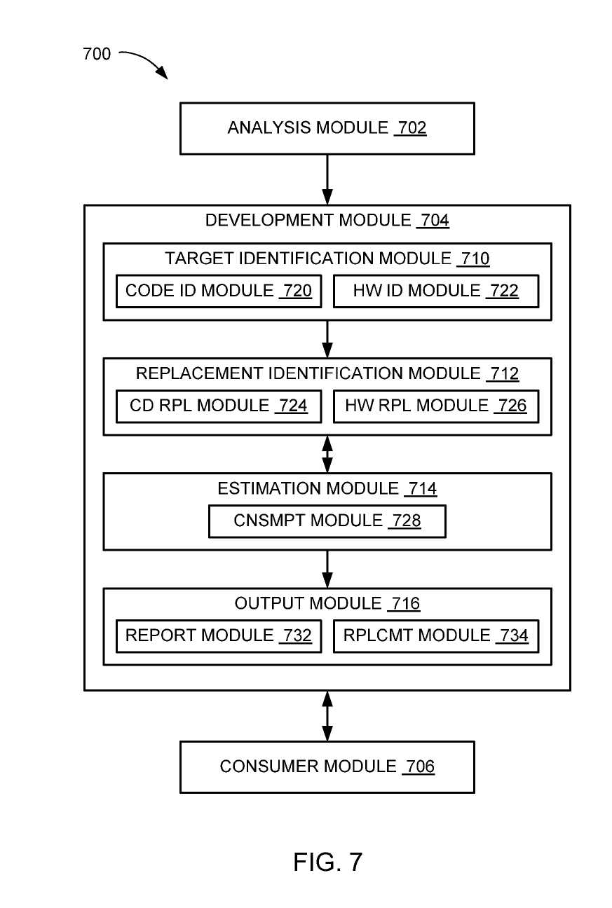

Referring now to FIG. 7, therein is shown a control flow 700 of the computing system 100 of FIG. 1. The computing system 100 can include an analysis module 702, a development module 704, a consumer module 706, or a combination thereof.

The analysis module 702 can be coupled to the development module 704, the development module 704 can be further coupled to the consumer module 706, or a combination thereof. The modules can be coupled by having the input of one module connected to the output of another, such as by using wired or wireless connections, the network 104 of FIG. 1, instructional steps, process sequence, or a combination thereof.

The modules can be coupled directly, without any other intervening structures other than the structure providing the direct connection. The modules can further be coupled indirectly, through a shared connection or other functional structures between the coupled modules.

The computing system 100 can operate a device, such as by displaying images, recreating sounds, executing or exchanging process steps or instructions, or a combination thereof with or based on the analysis module 702, the development module 704, the consumer module 706, or a combination thereof. The computing system 100 can also operate the device by having the device perform or execute designated instructions, sending designated instructions to the device, or a combination thereof using one or more of the modules listed above.

The computing system 100 can communicate by sending or receiving changes in energy, fluctuations or magnitudes in electro-magnetic characteristic, or a combination thereof between devices. The computing system 100 can communicate with a user by displaying information, providing tactile stimulation, producing sounds, or a combination thereof.

The analysis module 702 is configured to process the consumption model 424 of FIG. 4. The analysis module 702 can use the input sequence 402 of FIG. 4, corresponding instance of the consumption measurement 404 of FIG. 4, or a combination thereof to determine the state model 422 of FIG. 4. The analysis module 702 can generate the consumption model 424 based on the state model 422. Details regarding the analysis module 702 will be described below.

The development module 704 is configured to generate the application 302 of FIG. 3. The development module 704 can generate the application 302 based on the application code 502 of FIG. 5. The development module 704 can use the framework portion 310 of FIG. 3 for interfacing with the developer to receive the application code 502. The development module 704 can further process the application code 502 for optimizing the resource consumption of the application 302. The development module 704 can process the application code 502 based on the state model 422, the consumption model 424, or a combination thereof from the analysis module 702.

The development module 704 can include a target identification module 710, a replacement identification module 712, an estimation module 714, an output module 716, or a combination thereof. The target identification module 710 can be coupled to the replacement identification module 712, which can be further coupled to the estimation module 714. The estimation module 714 can be coupled to the output module 716. The modules can be coupled together as described above, similar to the coupling between the analysis module 702 and the development module 704.

The target identification module 710 is configured to determine a subject of an analysis process for optimizing the resource consumption. The target identification module 710 can identify one or more instructions or processes as an object for the analysis, identify one or more devices corresponding to the instructions or processes for the analysis, or a combination thereof. The target identification module 710 can include a code identification module 720, a hardware identification module 722, or a combination thereof.

The code identification module 720 is configured to identify the target section 504 of FIG. 5, the target code 506 of FIG. 5, or a combination thereof for the analysis process. The code identification module 720 can identify the target code 506, the target section 504, or a combination thereof based on accessing the application code 502.

The code identification module 720 can access the application code 502 stored in the first storage unit 214 of FIG. 2, the second storage unit 246 of FIG. 2, or a combination thereof. The code identification module 720 can access the application code 502 using the first control unit 212 of FIG. 2, the second control unit 234 of FIG. 2, the first storage interface 224 of FIG. 2, the second storage interface 248 of FIG. 2, or a combination thereof. The code identification module 720 can identify the target section 504, the target code 506, or a combination thereof within the application code 502 using a variety of methods.

For example, the code identification module 720 can identify the target section 504 sequentially. The code identification module 720 can identify the grouping of instructions or codes, such as using brackets, indentations, comments, “end of line” or “end of file” character, or a combination thereof, according to order of operation dictated by the instructions or codes, written or stored ordering within the instructions or codes, or a combination thereof.

Also for example, the code identification module 720 can identify the target section 504 based on user interaction. As a more specific example, the code identification module 720 can identify the grouping of instructions or codes on the first display interface 230 of FIG. 2, the second display interface 240 of FIG. 2, or a combination thereof as the target section 504. Also as a more specific example, the code identification module 720 can identify the grouping of instructions or codes by receiving a selection or a designation from the user through the first user interface 218 of FIG. 2, the second user interface 238 of FIG. 2, or a combination thereof.

Also for example, the code identification module 720 can include an order or sequence based on categorization or type of the code or the instruction. As a more specific example, the code identification module 720 can include order or sequence for identifying certain function calls, library instructions, or a combination thereof.

The code identification module 720 can similarly identify the target code 506. For example, the code identification module 720 can identify the target code 506 sequentially, user interaction, predetermined order or sequence, or a combination thereof.

The code identification module 720 can identify the target code 506 then identify the target section 504 relative to the target code 506. The code identification module 720 can further identify the target section 504 then identify the target code 506 relative to the target section 504.

The code identification module 720 can use the first control unit 212, the second control unit 234, or a combination thereof to identify the target section 504, the target code 506, or a combination thereof. The code identification module 720 can store the target section 504, the target code 506, or a combination thereof in the first storage unit 214, the second storage unit 246, or a combination thereof. The code identification module 720 can further communicate the target section 504, the target code 506, or a combination thereof, such as by highlighting or using an audible cue, using the first user interface 218, the second user interface 238, or a combination thereof.

The hardware identification module 722 is configured to identify one or more devices corresponding to the instructions or processes for the analysis. The hardware identification module 722 can identify one or more instances of the component 231 of FIG. 2 corresponding to the target section 504, the target code 506, or a combination thereof. The hardware identification module 722 can identify the one or more instances of the component 231 associated with executing the target section 504, the target code 506, or a combination thereof.

The hardware identification module 722 can identify the components 231 corresponding to the target section 504, the target code 506, or a combination thereof based on the framework portion 310, the implementation portion 314 of FIG. 3, or a combination thereof. For example, the hardware identification module 722 can identify the components 231 based on correlations or associations in drivers, toolboxes, address, designation, or a combination thereof between the target section 504, the target code 506, or a combination thereof and one or more instances of the components 231.

Also for example, the hardware identification module 722 can include associations or correlations between instructions, codes, function calls, API, or a combination thereof and one or more instances of the components 231. Also for example, the hardware identification module 722 can identify the components 231 by executing the target code 506, the target section 504, or a combination thereof, identifying one or more instances of the components 231 responding thereto, and recording the responding instances with respect to the executed instance of the target code 506, the target section 504, or a combination thereof.

The hardware identification module 722 can identify the components 231 using the first control unit 212, the second control unit 234, or a combination thereof. The hardware identification module 722 can identify the components 231 using the association or correlation information stored in the first storage unit 214, the second storage unit 246, or a combination thereof. The hardware identification module 722 can further identify the components 231 using various interfaces, such as the first communication interface 228 of FIG. 2, the second communication interface 250 of FIG. 2, the first storage interface 224, the second storage interface 248, or a combination thereof.

After identifying the code, the instruction, the corresponding component, or a combination thereof, the control flow 700 can be passed to the replacement identification module 712. The control flow 700 can pass through a variety of ways. For example, control flow 700 can pass by having processing results of one module passed to another module, such as by passing the target code 506, the target section 504, the corresponding component, or a combination thereof from the target identification module 710 to the replacement identification module 712, by storing the processing results at a location known and accessible to the replacement identification module 712, by notifying the replacement identification module 712, such as by using a flag, an interrupt, a status signal, or a combination thereof, or a combination of processes thereof.

The replacement identification module 712 is configured to determine alternatives corresponding to the target code 506, the target section 504, or a combination thereof. The replacement identification module 712 can determine the suggestion bank 516 of FIG. 5 for the target code 506, the target section 504, or a combination thereof.

The replacement identification module 712 can determine instructions, code, components, or a combination thereof as alternates for replacing the target code 506, the target section 504, or a combination thereof. The replacement identification module 712 can include a code replacement module 724, a hardware replacement module 726, or a combination thereof.

The code replacement module 724 is configured to determine the instructions or the code for replacing the target code 506, the target section 504, or a combination thereof. The code replacement module 724 can determine the alternate code 518 of FIG. 5 corresponding to the target code 506, the target section 504, or a combination thereof.

The code replacement module 724 can determine the alternate code 518 using a variety of methods. For example, the code replacement module 724 can determine the alternate code 518 by determining groupings, clusters, classes, weights, models, or a combination thereof for associated or similar instructions or codes using machine-learning mechanism. Also for example, the code replacement module 724 can determine categories or types using pattern recognition mechanism. As a more specific example, the code replacement module 724 can determine groupings, classes, weights, models, or a combination thereof using common driver functions, API calls, or a combination thereof.

Also for example, the code replacement module 724 can further use categories, groupings, classes, weights, models, or a combination thereof predetermined by the computing system 100. The code replacement module 724 can determine alternates corresponding to the target code 506, the target section 504, or a combination thereof by identifying the category, grouping, class, weight, model, or a combination thereof including the target code 506, the target section 504, a portion therein, a keyword therein, a synonym or a content similar therein, or a combination thereof.

The hardware replacement module 726 is configured to determine one or more instances of the components 231 for replacing the target code 506, the target section 504, or a combination thereof. The hardware replacement module 726 can determine an alternate component 520 of FIG. 5 corresponding to the target code 506, the target section 504, or a combination thereof.

The hardware replacement module 726 can determine the alternate component 520 similar to the code replacement module 724, the hardware identification module 722, or a combination thereof. For example, the hardware replacement module 726 can determine the alternate component 520 by determining groupings, clusters, classes, weights, models, or a combination thereof for associated or similar components using machine-learning mechanism. Also for example, the hardware replacement module 726 can use pattern recognition for determining categories or types for the components 231, or a combination thereof.

Also for example, the hardware replacement module 726 can determine the alternate component 520 based on the framework portion 310, the implementation portion 314, or a combination thereof. The hardware replacement module 726 can use drivers, toolboxes, address, designation, or a portion therein, or a combination thereof. For further example, the hardware replacement module 726 can determine the alternate component 520 based on identifying one or more groupings corresponding to the target code 506, the target section 504, or a combination thereof within overall collection of the groupings or associations of the components 231.

The replacement identification module 712 can further determine the alternate consumption 522 of FIG. 5, the alternate performance 524 of FIG. 5, or a combination thereof associated with the alternate code 518, the alternate component 520, or a combination thereof. The replacement identification module 712 can use the consumption model 424, the state model 422, or a combination thereof.

For example, the replacement identification module 712 can determine the alternate consumption 522 based on the consumption model 424 corresponding to the function state 426 of FIG. 4, the change condition 428 of FIG. 4, or a combination thereof corresponding to the alternate code 518, the alternate component 520 or a combination thereof. Also for example, the replacement identification module 712 can determine the alternate performance 524 based on the state model 422 and the change condition 428 associated with the alternate code 518, the alternate component 520 or a combination thereof.

The replacement identification module 712 can use the first control unit 212, the second control unit 234, or a combination thereof to determine the suggestion bank 516. The replacement identification module 712 can use the first storage interface 224, the second storage interface 248, the first communication interface 228, the second communication interface 250, or a combination thereof to access information for determining the suggestion bank 516. The replacement identification module 712 can further store the suggestion bank 516 in the first storage unit 214, the second storage unit 246, or a combination thereof.

After determining the suggestion bank 516, the control flow 700 can be passed to the estimation module 714. The control flow 700 can pass similarly as described above between the target identification module 710 and the replacement identification module 712, but using the processing results of the replacement identification module 712, such as the suggestion bank 516.

The estimation module 714 is configured to estimate an amount of consumption associated with the application code 502 of FIG. 5. The estimation module 714 can estimate for the target code 506, the target section 504, the subsequent code 514, or a combination thereof within the application code 502. The estimation module 714 can further estimate the amount of consumption for the suggestion bank 516.

The estimation module 714 can identify and access various information for the estimation. For example, the estimation module 714 can identify and access the consumption model 424 corresponding to the application code 502, the target code 506 or the target section 504 therein, the suggestion bank 516, or a combination thereof.

The estimation module 714 can estimate by calculating the consumption estimate 508 of FIG. 5, the temporal estimate 510 of FIG. 5, or a combination thereof. The estimation module 714 can calculate results corresponding to the target code 506, the target section 504, the subsequent code 514, the suggestion bank 516, or a combination thereof. The estimation module 714 can include a consumption module 728, or a combination thereof.

The consumption module 728 is configured to estimate resource consumption and performance associated with the application code 502. The consumption module 728 can calculate the consumption estimate 508, the temporal estimate 510, or a combination thereof for the target code 506, the target section 504, the subsequent code 514, the suggestion bank 516, or a combination thereof. The consumption module 728 can calculate based on the consumption model 424, the state model 422, or a combination thereof.

The consumption module 728 can calculate the consumption estimate 508 by determining the function state 426, the change condition 428, or a combination thereof corresponding to the instructions, the codes, or a combination thereof in the application code 502. The consumption module 728 can determine the function state 426, the change condition 428, or a combination thereof corresponding to portions preceding or following the target code 506, the target section 504, or a combination thereof. The consumption module 728 can further determine the function state 426, the change condition 428, or a combination thereof corresponding to the target code 506, the target section 504, or a combination thereof.

The consumption module 728 can identify the consumption model 424 or a portion therein, corresponding to the function state 426, the change condition 428, or a combination thereof for each or a portion of the instructions or codes within the application code 502. For example, the consumption module 728 can identify the function-specific consumption 442 of FIG. 4, the combined-state consumption 444 of FIG. 4, the state-decomposition consumption 446 of FIG. 4, the consumption rating 448 of FIG. 4, or a combination thereof corresponding to one or a grouping of instructions or lines of codes within the application code 502.

The consumption module 728 can calculate the consumption estimate 508 for executing one or a grouping of the instructions or codes using the corresponding instance of the consumption model 424. The consumption module 728 can calculate the consumption estimate 508 for groupings of codes or instructions as predetermined by the computing system 100. For example, the consumption module 728 can calculate the consumption estimate 508 for codes or instructions preceding and following the target code 506 or the target section 504, along with analyzing the target code 506 or the target section 504.

The consumption module 728 can use the groupings to calculate a cumulative effect or an effect specific to certain combinations of codes or instructions, such as for the state-decomposition consumption 446. The consumption module 728 can analyze codes or instructions surrounding each of the instructions or codes to identify conditions for the state-decomposition consumption 446. The consumption module 728 can adjust the consumption estimate 508 for a specific instance of the code, instruction, or a grouping thereof when the state-decomposition consumption 446 is applicable.

The consumption module 728 can similarly calculate the consumption estimate 508 for the suggestion bank 516. The consumption module 728 can calculate the consumption estimate 508 as the alternate consumption 522. The consumption module 728 can further update or adjust the alternate consumption 522 using the consumption estimate 508.

The consumption module 728 can further calculate the consumption estimate 508 for the grouping of codes or instructions with the target code 506 or the target section 504 replaced with the alternate code 518 or the alternate component 520. For example, the consumption module 728 can calculate the consumption estimate 508 using different sequences or configurations of codes or instructions, different instructions or codes, different components, or a combination thereof along with surrounding codes or instructions.

It has been discovered that the consumption estimate 508 calculated using groupings of codes or instructions and the state-decomposition consumption 446 provides increased accuracy in estimating the resource consumption. The grouping and the state-decomposition consumption 446 can be used to account for cumulative effects deviating from simple combining of consumption models, such as based on parallel operation or executions by the components 231 overlapping each other, delayed execution, exceptions, or a combination thereof.

The consumption module 728 can further calculate the consumption estimate 508 for an average consumption, a minimum consumption, a worst-case consumption, or a combination thereof. The consumption module 728 can calculate the average consumption based on a cumulative effect in executing the target code 506 or the target section 504 and most frequently occurring or scheduled operation of the implementation portion 314, such as the operating system scheduler or kernel operation. The consumption module 728 can further calculate the minimum consumption, the worst-case consumption, or a combination thereof based on possible operation of the implementation portion 314 indicating the state-decomposition consumption 446.

The consumption module 728 can calculate the temporal estimate 510 by similarly calculating the execution time or delay time as indicated in the consumption model 424. For example, the consumption module 728 can calculate the temporal estimate 510 by analyzing groupings of code or instructions and calculating amount of time necessary for the execution to finish based on resource consumption.

Also for example, the consumption module 728 can calculate the temporal estimate 510 for the alternate code 518, the alternate component 520, or a combination thereof. The consumption module 728 can use the temporal estimate 510 to set or update the alternate performance 524. Also for example, the consumption module 728 can account for interactions or effects from other codes, instructions, the implementation portion 314, or a combination thereof and adjust the temporal estimate 510 accordingly.

The consumption module 728 can further calculate the consumption estimate 508, the temporal estimate 510, or a combination thereof based on the historical user-feedback 456 of FIG. 4. For example, the consumption module 728 can calculate the consumption estimate 508 based on previous usage history or pattern and associated consumption records. The consumption module 728 can log various usages, commands or functions associated thereto, along with amount or rate of consumption for the corresponding usage. The consumption module 728 can collect, receive, access, or a combination thereof for multiple users, devices, other instances of the application 302, or a combination thereof for the historical user-feedback 456.

The estimation module 714 can use the first control unit 212, the second control unit 234, or a combination thereof to calculate the consumption estimate 508, the temporal estimate 510, or a combination thereof. The estimation module 714 can use the first storage interface 224, the second storage interface 248, the first communication interface 228, the second communication interface 250, or a combination thereof to access information for calculating the estimations. The estimation module 714 can further store the calculated results in the first storage unit 214, the second storage unit 246, or a combination thereof.

After determining the estimations, the control flow 700 can be passed to the output module 716. The control flow 700 can pass similarly as described above between the target identification module 710 and the replacement identification module 712, but using the processing results of the estimation module 714, such as the consumption estimate 508, the temporal estimate 510, or a combination thereof.

The output module 716 is configured to optimize the resource consumption of the application code 502. The output module 716 can generate the code-power analysis output 526 for optimizing the resource consumption.

The output module 716 can generate the code-power analysis output 526 based on the consumption estimate 508, the state model 422, or a combination thereof. For example, the output module 716 can generate the code-power analysis output 526 to communicate the consumption estimate 508, or a combination thereof to the user. Also for example, the output module 716 can further generate the code-power analysis output 526 to adjust the application code 502 for optimizing the resource consumption.

The output module 716 can generate the code-power analysis output 526 by generating the consumption report 528 of FIG. 5, the replacement code 534 of FIG. 5, or a combination thereof. The output module 716 can include a report module 732, a replacement module 734, or a combination thereof.

The report module 732 is configured to generate the consumption report 528. The report module 732 can generate the consumption report 528 by communicating the consumption estimate 508, the temporal estimate 510, or a combination thereof corresponding to the application code 502 or a portion therein, including the target section 504 or the target code 506.

For example, the report module 732 can calculate the relative-highest section 530 of FIG. 5, the threshold breach 532 of FIG. 5, or a combination thereof for communicating to the user. The report module 732 can compare the instances of the consumption estimate 508, the temporal estimate 510, or a combination thereof corresponding to the code or the instructions within the application code 502, a section or a portion, including the target section 504, or a combination thereof.

Continuing with the example, the report module 732 can calculate the relative-highest section 530 as the code or the instruction corresponding to the highest instance of the consumption estimate 508, the temporal estimate 510, or a combination thereof, the value of the corresponding highest instance, or both. The report module 732 can communicate the relative-highest section 530 to the user, such as by identifying the line of code or the instruction causing the highest influence or by identifying the highest estimated amount or level.

Continuing with the example, the report module 732 can compare the instances of the consumption estimate 508, the temporal estimate 510, or a combination thereof corresponding to the code or the instructions within the application code 502, a section or a portion, including the target section 504, or a combination thereof to a reporting threshold predetermined by the computing system 100. The report module 732 can calculate the threshold breach 532 as the line of code or instruction exceeding the reporting threshold. The report module 732 can communicate the threshold breach 532 similar to communicating the relative-highest section 530 as described above.

As a more specific example, the report module 732 can notify the developer when a line or a grouping of code or instruction is estimated to use more than a designated amount of power or overheat the component. Also as a more specific example, the report module 732 can highlight or underline the line or the grouping of code or instruction corresponding to the relative-highest section 530, the threshold breach 532, or a combination thereof.

The replacement module 734 is configured to generate the replacement code 534. The replacement module 734 can generate the replacement code 534 for substituting the target code 506, the target section 504, or a combination thereof based on lowering the consumption estimate 508.

The replacement module 734 can generate the replacement code 534 by comparing the consumption estimate 508, the temporal estimate 510, or a combination thereof corresponding to the target code 506 or the target section 504 against the alternate consumption 522, the alternate performance 524, or a combination thereof. The replacement module 734 can generate the replacement code 534 as the target code 506, the target section 504, the alternate code 518, the alternate component 520, or a combination thereof corresponding to the optimal instance of the consumption estimate 508, the temporal estimate 510, or a combination thereof.

For example, the replacement module 734 can generate the replacement code 534 as the alternate code 518, the alternate component 520, or a combination thereof having value or rating of the consumption estimate 508, or a combination thereof lower than that of the target code 506 or the target section 504. Also for example, the replacement module 734 can generate the replacement code 534 as the alternate code 518, the alternate component 520, or a combination thereof having the lowest value of the consumption estimate 508, the temporal estimate 510, or a combination thereof as represented by the alternate consumption 522, the alternate performance 524.

Also for example, the replacement module 734 can generate the replacement code 534 based on balancing the consumption estimate 508, or a combination thereof against the temporal estimate 510. The replacement module 734 can generate the replacement code 534 as the alternate code 518, the alternate component 520, or a combination thereof having the lowest value of the consumption estimate 508, or a combination thereof while satisfying a minimum, a maximum, a categorical, or a combination of limitations associated with the temporal estimate 510.

Also for example, the replacement module 734 can further generate the replacement code 534 using weights or adjustment factors representing importance or value attributed to the consumption estimate 508, the temporal estimate 510, or a combination thereof. The replacement module 734 can apply the weights or adjustment factors to the consumption estimate 508, the temporal estimate 510, or a combination thereof.

Continuing with the example, the replacement module 734 can combine the combination of the weights or adjustment factors and the consumption estimate 508, the temporal estimate 510, or a combination thereof to calculate an overall assessment metric using an equation or a method predetermined by the computing system 100. The replacement module 734 can generate the replacement code 534 as the alternate code 518, the alternate component 520, or a combination thereof based on the overall assessment metric.

Also for example, the replacement module 734 can generate the replacement code 534 based on known environmental or conditional factors. As a more specific example, the replacement module 734 can generate the replacement code 534 as the alternate code 518, the alternate component 520, or a combination thereof optimizing the consumption estimate 508, the temporal estimate 510, or a combination thereof according to the device profile 450 of FIG. 4, the user profile 452 of FIG. 4, or a combination thereof using the historical user-feedback 456.

As a more specific example, the replacement module 734 can generate the replacement code 534 by generating the sequential adjustment 538 of FIG. 5 for the target code 506 for sequentially reordering the target code 506 within the application code 502 based on lowering the consumption estimate 508, the temporal estimate 510, or a combination thereof. The replacement module 734 can analyze the different configurations or sequential orders for the target code 506 according to the alternate code 518. The replacement module 734 can generate the sequential adjustment 538 as the alternate code 518 rearranging the target code 506 in an order or configuration optimizing the consumption estimate 508, the temporal estimate 510, or a combination thereof.

Also as a more specific example, the replacement module 734 can generate the code-power analysis output 526 for combining the task 304 of FIG. 3, the thread 306 of FIG. 3, the routine 308 of FIG. 3, or a combination thereof. The replacement module 734 can generate the parallel configuration 536 of FIG. 5, the queue adjustment 540 of FIG. 5, or a combination thereof.

Continuing with the example, the replacement module 734 can generate the parallel configuration 536 as the alternate code 518, the alternate component 520, or a combination thereof for simultaneously executing multiple instances of the task 304, the thread 306, the routine 308, or a combination thereof. The replacement module 734 can execute across multiple instances of the components 231 or devices prior to finishing one or more of the instruction, line of code, process, or a combination thereof. The replacement module 734 can use different sequences, different function or API call, different configuration, or a combination thereof through the alternate code 518, the alternate component 520, or a combination thereof.

Continuing with the example, the replacement module 734 can generate the queue adjustment 540 as the alternate code 518, the alternate component 520, or a combination thereof for adjusting a timing for executing an instruction or a function. The replacement module 734 can generate the queue adjustment 540 as a conditional statement or an input requirement for delaying execution or implementation of the instruction or the function corresponding to the target code 506, such as to maximize allotted communication load potential or to spread out a usage or access to a specific instance of the components 231.

The replacement module 734 can further generate the replacement code 534 by communicating the replacement code 534 to the developer in a variety of ways. For example, the replacement module 734 can generate the replacement code 534 by automatically replacing the target code 506 or the target section 504 with the replacement code 534. Also for example, the replacement module 734 can generate the replacement code 534 by displaying the replacement code 534 or an association thereof with the target code 506 or the target section 504, such as using a side panel or a pop-up notice.

It has been discovered that the consumption report 528 provides improved usability in optimizing the resource consumption through developing the application code 502. The consumption report 528 can provide the development environment where the consumption estimate 508, the temporal estimate 510, or a combination thereof are readily available to the developer. The consumption report 528 can further model existing information or features in the development environment, such as detailed view or debugging environment, to present information regarding the resource consumption without the need for separate or external analysis.

It has also been discovered that the replacement code 534 for replacing the target code 506 or the target section 504 provides efficient resource management while reducing development burdens. The replacement code 534 can provide the developer with alternative implementations that can reduce the resource consumption and other consequences in executing the application code 502. The replacement code 534 can reduce the analysis and comparisons required for accessing, testing, recognizing, and implementing variety of alternatives for the target section 504 and the target code 506, and further utilize viable alternatives without additional processes.

It has further been discovered that the replacement code 534 for combining usage of multiple instances of the task 304, the thread 306, the routine 308, or a combination thereof provides systematic usage of parallel processing and optimization of inherent delays. The replacement code 534 can provide design options with hardware considerations for software developers not mindful of the hardware aspect in developing the application 302.

It has further been discovered that the replacement code 534 based on the device profile 450, the user profile 452, or a combination thereof provides personalization in maximizing efficiency in resource management. The replacement code 534 considering and utilizing the device-specific characteristics, such as specific instances of the components 231 therein or user's habits and patterns, provides the developer ability to develop the application 302 capable of utilizing the uniqueness of the user and the user's device in managing resources.

The consumer module 706 is configured to process the consumer environment 602 of FIG. 6. The consumer module 706 can process the consumer environment 602 based on the consumption model 424, the application 302 incorporating the code-power analysis output 526, or a combination thereof. The consumer module 706 can process the consumer environment 602 including the descriptive portion 608 of FIG. 6 customized based on the user, user's device, or a combination thereof. Details regarding the consumer module 706 will be described below.

The control flow 700 or the method 700 of operation of the computing system 100 includes: accessing an application code including a target code; identifying a consumption model corresponding to the target code; calculating a consumption estimate for the target code based on the consumption model; and generating a code-power analysis output with a control unit based on the consumption estimate.

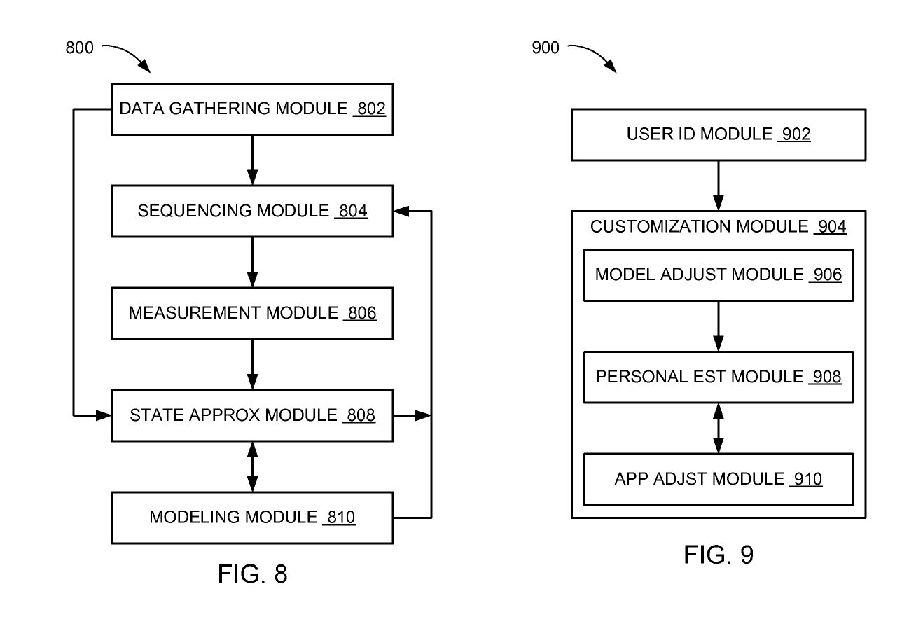

Referring now to FIG. 8, therein is shown a detailed example of the analysis module 702 of FIG. 7. The analysis module 702 can include a data gathering module 802, a sequencing module 804, a measurement module 806, a state approximation module 808, a modeling module 810, or a combination thereof.

The data gathering module 802 can be coupled to the sequencing module 804, which can be further coupled to the measurement module 806. The measurement module 806 can be coupled to the state approximation module 808, which can be further coupled to the modeling module 810. The data gathering module 802 can be further coupled to the state approximation module 808, and the modeling module 810 can be further coupled to the sequencing module 804. The modules can be coupled in variety of ways as described above between the analysis module 702 and the development module 704 of FIG. 7.

The data gathering module 802 is configured to identify existing or available information regarding the first device 102 of FIG. 1, one or more of the components 231 of FIG. 2 therein, or a combination thereof. The data gathering module 802 can identify the existing or available information by searching, receiving, determining, or a combination thereof for identifying the input sequence 402 of FIG. 4.

The data gathering module 802 can identify the device profile 450 of FIG. 4, one or more of the components 231 therein, or a combination thereof available or accessible for the application 302 of FIG. 3. The data gathering module 802 can access information, such as specification data, information regarding the implementation mechanism 316 of FIG. 3 including the system scheduler 410 of FIG. 4, prior test data, existing state diagram, the historical user-feedback 456 of FIG. 4, or a combination thereof corresponding to the device profile 450 or the one or more of the components 231 therein.

The data gathering module 802 can identify the device profile 450 based on a grouping or a list of devices or the components 231 predetermined by the developer of the application 302, the computing system 100 of FIG. 1, or a combination thereof. The data gathering module 802 can access a manufacturer database, information predetermined or preloaded by the computing system 100, or a combination thereof to access the information. The data gathering module 802 can further use processes or methods predetermined by the computing system 100 to search the internet or various databases to access the information.

The data gathering module 802 can use an instance of the application 302 designated for testing or analysis purposes. The application 302 can include functions, API calls, processes, features, or a combination thereof available to the developers in developing the application code 502 of FIG. 5 for a different consumer instance of the application 302.

The data gathering module 802 can further identify various input and output combinations of the testing instance of the application 302 subject to analysis. The data gathering module 802 can identify the information regarding the application 302 using methods similar to ones described above for the hardware components.

The data gathering module 802 can use the first communication unit 216 of FIG. 2, the second communication unit 236 of FIG. 2, the first storage interface 224 of FIG. 2, the second storage interface 248 of FIG. 2, or a combination thereof to access the various types of information. The data gathering module 802 can use the first control unit 212 of FIG. 2, the second control unit 234 of FIG. 2, or a combination thereof to identify the desired information.

After identifying relevant information, the control flow 800 can be passed to the sequencing module 804. The control flow 800 can pass similarly as described above between the target identification module 710 and the replacement identification module 712 of FIG. 7.

The sequencing module 804 is configured to determine an order and a timing associated with controlling the components 231. The sequencing module 804 can determine an order or a sequence for operating the testing instance of the application 302 and execution thereof on the first device 102. The sequencing module 804 can identify the input sequence 402 or the application call 408 of FIG. 4 therein for the application 302.

The sequencing module 804 can use patterns, rules, logic, conditions, or a combination thereof predetermined by the computing system 100 to determine an order for the application call 408 determined by the data gathering module 802. The ordered instances of the application call 408 can be the usage scenario 406 of FIG. 4.

The sequencing module 804 can generate instances of the usage scenario 406 as test inputs or test cases for the application 302. The sequencing module 804 can alternatively use an instance of the application 302 designated for testing specific functions, features, component, device, or a combination thereof through executing the usage scenario 406. The sequencing module 804 can further receive inputs or information from a testing entity for the sequence or the application 302.

The sequencing module 804 can use the first control unit 212, the second control unit 234, or a combination thereof to determine the usage scenario 406 for the analysis environment. The sequencing module 804 can store the usage scenario 406 in the first storage unit 214 of FIG. 2, the second storage unit 246 of FIG. 2, or a combination thereof.

After determining the test stimulus, the control flow 800 can be passed to the measurement module 806. The control flow 800 can pass similarly as described above between the target identification module 710 and the replacement identification module 712 of FIG. 7.

The measurement module 806 is configured to determine and further process output data from the test. The measurement module 806 can execute the test stimulus for the application 302 on the first device 102, while recording various characteristics of the first device 102, the components 231 therein, input or output data, or a combination thereof.

For example, the measurement module 806 can use the first control unit 212, the second control unit 234, or a combination thereof to execute the test stimulus for the application 302. The measurement module 806 can use the first control interface 222 of FIG. 2, the second control interface 244 of FIG. 2, or a combination thereof to log status and time of various operations and commands internal to the first device 102, specific for the components 231 therein, or a combination thereof. Also for example, the measurement module 806 can use the sensor 219 of FIG. 2, the first communication unit 216, the second communication unit 236, or a combination thereof to determine the consumption measurement 404 of FIG. 4 for representing the first device 102 executing the application 302.

The measurement module 806 can further process the consumption measurement 404 (including resource consumption) in a variety of ways. For example, the measurement module 806 can identify the input sequence 402 corresponding to the consumption measurement 404, such as by aligning the input data with the output data, determining a change in output relative to a response time for a corresponding input stimulus, or a combination thereof.

As a more specific example, the measurement module 806 can identify a complete instance of the input sequence 402, including the test stimulus portion represented by the usage scenario 406 and including the system call 412 of FIG. 4 of the system scheduler 410 using the logged commands and processes. The measurement module 806 can identify the input-corresponding portion 416 of FIG. 4 for the consumption measurement 404 corresponding to the input sequence 402 based on a change in resource consumption within the response time specified by the available data.

Also for example, the measurement module 806 can calculate the fitting estimation 420 of FIG. 4 for the consumption measurement 404. The measurement module 806 can calculate the fitting estimation 420 as the level of resource consumption. The measurement module 806 can filter out noise, eliminate any inconsequential shifts or offsets, or a combination thereof to calculate quantity or intensity attributable to the execution of the test input.

As a more specific example, the measurement module 806 can use a shifting window, matching filter, averaging mechanism, or a combination thereof to calculate the fitting estimation 420. Also as a more specific example, the measurement module 806 can use a convex-optimization mechanism, including calculating the area under the model curve to determine state transition locations, for calculating the fitting estimation 420. The measurement module 806 can use the convex-optimization mechanism utilizing a convex problem with “n” representing size or length of the consumption measurement 404 of:

Minimize Σ|I_{fit}−I_{data}|,subject to Σ|I_{fit}(1: n−1)−I_{fit}(2:n)|<σ.

It has been discovered that the consumption measurement 404 utilizing the fitting estimation 420 from the convex optimization mechanism provides improved accuracy for identifying various states and associated levels or quantities. The fitting estimation 420 from the convex optimization mechanism calculates the area under the model curve and accurately determines state transition locations.

After determining the consumption measurement 404, the input sequence 402, the relationship there-between, or a combination thereof, the control flow 800 can be passed to the state approximation module 808. The control flow 800 can pass similarly as described above between the target identification module 710 and the replacement identification module 712.

The state approximation module 808 is configured to determine the state model 422 of FIG. 4 for representing consumer instances of the application 302, the first device 102, or a combination thereof. The state approximation module 808 can determine the state model 422 based on the consumption measurement 404, the input sequence 402, or a combination thereof.

The state approximation module 808 can determine the state model 422 based on transitions in the consumption measurement 404 with the fitting estimation 420. The state approximation module 808 can include a transition threshold. The state approximation module 808 can identify separate instances of the function state 426 of FIG. 4 based on the consumption measurement 404 with the fitting estimation 420 exceeding the transition threshold, such as change in amount of current or temperature within a designated time window as predetermined by the computing system 100.

The state approximation module 808 can associated the function state 426 identified in the input-corresponding portion 416 with the application call 408, the system call 412, or a combination thereof correlated with the input-corresponding portion 416. The state approximation module 808 can determine the change condition 428 of FIG. 4 based on previously-occurring instance of the function state 426, a preceding instance of the application call 408, the system call 412, or a combination thereof, duration of time at the previously-occurring instance of the function state 426 or a combination thereof.

For example, the state approximation module 808 can determine the condition trigger 436 of FIG. 4 for a specific instance of the function state 426 as the application call 408, the system call 412, or a combination thereof preceding the specific instance of the function state 426, associated with the input-corresponding portion 416 corresponding to the function state 426, or a combination thereof. Also for example, the state approximation module 808 can determine the residency time 438 of FIG. 4 for the specific instance of the function state 426 as the duration of time spent in the function state 426 according to the consumption measurement 404, the various external data, or a combination thereof. Also for example, the state approximation module 808 can determine the next-state 440 based on the specific instance of the function state 426 and the preceding instance of the function state 426.

The state approximation module 808 can further determine the overlap portion 418 of FIG. 4 for the consumption measurement 404. The state approximation module 808 can compare the application call 408, the system call 412, or a combination thereof and time duration associated therewith according to the various external data to the input sequence 402. The state approximation module 808 can identify instances where one instance of the application call 408 or the system call 412 occurs before a projected end of a previously occurring instance of the application call 408 or the system call 412.

The state approximation module 808 can match the timing of such instance to the consumption measurement 404. The state approximation module 808 can identify the overlap portion 418 as the portion of the consumption measurement 404 corresponding to multiple instances of the application call 408, the system call 412, or a combination thereof.

The state approximation module 808 can access other portions of the input sequence 402 to find independent and singular instances of the application call 408, the system call 412, or a combination thereof in the overlap portion 418. The state approximation module 808 can correlate the multiple corresponding instances of the function state 426 to the overlap portion 418.

After processing the function state 426, the control flow 800 can pass to the modeling module 810, the sequencing module 804, or a combination thereof. The various instances of the function state 426 identified by the state approximation module 808 can be passed to the sequencing module 804 to adjust and regenerate the input sequence 402. For example, the possible instances contributing to the overlap portion 418 can be tested independently using greater delays before and after associated instances of the application call 408 or the system call 412. Also for example, the timing for the sequence can be adjusted to test the residency time 438.

The adjusted instance of the input sequence 402 can be tested and measured with the measurement module 806. The result can be combined with the previous instance of the consumption measurement 404 in the state approximation module 808 to refine the state model 422. After a number of iterations predetermined by the computing system 100 or based on meeting a condition or a requirement predetermined by the computing system 100, the control flow 800 can pass to the modeling module 810.

The modeling module 810 is configured to generate the consumption model 424 of FIG. 4 for representing various instances of the application 302. The modeling module 810 can generate the consumption model 424 based on associating a level, a magnitude, a quantity, or a combination thereof based on the fitting estimation 420 of the consumption measurement 404 with the function state 426, the change condition 428, or a combination thereof corresponding to the consumption measurement 404.

The modeling module 810 can generate the consumption model 424 for estimating various characteristics associated to executing a command, a function, or a process through consumer instances of the application 302. The modeling module 810 can generate the consumption model 424 including the function-specific consumption as an amount of consumption, an intensity of the reaction, a duration according to the change condition 428, a sequence of the function state 426, a pattern thereof, or a combination thereof likely to occur in executing a specific instance of the application call 408 or the system call 412.

For example, the modeling module 810 can identify a grouping or a sequence for the instances of the function state 426 associated with the application call 408 or the system call 412. The modeling module 810 can associate a level of resource consumption for each instance of the function state 426. The modeling module 810 can further associate a duration for each of the states. The modeling module 810 can generate the function-specific consumption 442 of FIG. 4 as the associated grouping of the sequence, the level of consumption, the duration, or a combination thereof corresponding to the application call 408 or the system call 412 applicable to the application 302.

The modeling module 810 can further generate the consumption model 424 based on the combined-state consumption 444 of FIG. 4, the state-decomposition consumption 446 of FIG. 4, or a combination thereof. The modeling module 810 can use the first control unit 212, the second control unit 234, or a combination thereof to analyze the overlap portion 418 implicating the combined-state consumption 444 or the state-decomposition consumption 446.

The modeling module 810 can calculate the combined-state consumption 444, the state-decomposition consumption 446, or a combination thereof using a variety of methods. For example, the modeling module 810 can calculate the combined-state consumption 444, the state-decomposition consumption 446, or a combination thereof using machine-learning mechanism, a pattern recognition mechanism, or a combination thereof.

The modeling module 810 can analyze the overlap portion 418 and the instances of the function state 426 associated therewith, along with other independent instances of the function state 426 occurring alone or in combination with other inputs or states. The modeling module 810 can calculate a pattern in the corresponding consumption levels.

The modeling module 810 can identify combinations of the application call 408, the system call 412, or a combination thereof resulting in non-additive levels or patterns for the consumption measurement 404. The modeling module 810 can use a decomposition threshold, including minimum or maximum of levels or durations, to distinguish an influencing subsystem and an influenced subsystem. The modeling module 810 can use the decomposition threshold to identify and eliminate the influencing relationship. The modeling module 810 can generate the state-decomposition consumption 446 as the non-additive levels or patterns and corresponding combinations of the application call 408, the system call 412, or a combination thereof.

For example, a certain amount of CPU activity is present in during data collection for all the models, however the CPU activity does not double if SD card and WiFi are both active. The modeling module 810 can capture and account for the non-linear response in consumption using the state-decomposition consumption 446.

The modeling module 810 can use known instance of the consumption model 424 for the influencing subsystem to eliminate the relationship or identify a parameter that differentially affects the influencing and influenced subsystems, varying it and see which portion of the observed waveform changes. The modeling module 810 can interact with the sequencing module 804 to alter the input sequence 402 for testing which portion of the observed waveform changes.

Continuing with the example, the CPU and SD card have their own clock so the modeling module 810 can change the parameter “CPU clock frequency”. The computing system 100 can use the measurement module 806 and the state approximation module 808 as described above to observe its effects. The modeling module 810 can use results from multiple runs to identify and eliminate the influencing subsystem.

The modeling module 810 can include a method, a process, an equation, or a combination thereof for generating a hypothesis parameter, variable by the computing system 100, based on the overlap portion 418. The modeling module 810 can generate the hypothesis parameter that differentially affects the influenced and influencing subsystems, including instances of the component 231, the task 304 of FIG. 3, the thread 306 of FIG. 3, the routine 308 of FIG. 3, or a combination thereof.

The modeling module 810 can further establish the decomposition threshold, represented as “Emin” and “Emax”. The term “E” can represent a change in energy per unit change in parameter, represented as “P”. The term “Emin” can represent the minimum required change and the term “Emax” can represent the maximum allowable change, with “Emin>Emax”.

The modeling module 810 can interact with the state approximation module 808 to assign an instance of the function state 426 to the influencing subsystem if Emin<E. The modeling module 810 can similarly assign a different instance of the function state 426 to the influenced subsystem if E<Emax. The modeling module 810 can iteratively adjust or generate a notice if Emax<E<Emin.

The modeling module 810 can analyze various independent occurrences of a specific instance of the application call 408, the system call 412, or a combination thereof to calculate the combined-state consumption 444. The modeling module 810 can identify and account for inconsequential delays or pauses in the execution of the application call 408, the system call 412, or a combination thereof.

For example, in SD card write operations, a memory write operation can stage data in the RAM before it is written to the FLASH in SD card. The relationship between RAM write and FLASH write can be a variable one which depends on the size of data being written. Also the FLASH write itself can be split in to multiple operations. The modeling module 810 can ignore the distinctions for modeling energy consumed, and ignore the temporal distribution in small timespan for power modeling.

The modeling module 810 can identify a combined-state timespan, such that for any time t<T, only the total energy and not its temporal distribution is of interest for the consumption model 424. The modeling module 810 can further identify a combined-state threshold including an upper bound on maximum fitting error in energy Emax.

The modeling module 810 can analyze various preliminary instances of the consumption model 424 for the various independent occurrences of the specific instance of the application call 408, the system call 412, or a combination thereof. The modeling module 810 can require the preliminary instances of the consumption model 424 to include a time span less than the combined-state timespan.

The modeling module 810 can map variations of observed states to one of the prototype states. The modeling module 810 can determine power and times of the prototype state such that the total error<Emax. The modeling module 810 can further determine the power and times of the prototype state based on transitions or different levels of consumption thereof. The modeling module 810 can determine the prototype state model satisfying the requirements as the combined-state consumption 444 representing various possible variations.

The computing system 100 of FIG. 1 can use the analysis environment to generate various instances of the consumption model 424 corresponding to various different instances of the first device 102, the components 231, the application call 408, the system call 412, or a combination thereof. The computing system 100 can store the various instances of the consumption model 424 associated with the corresponding instance of the first device 102, the components 231, the application call 408, the system call 412, or a combination thereof.

It has been discovered that the state-decomposition consumption 446 provides accurate estimation of resource consumption. The state-decomposition consumption 446 can account for exceptions to additive patterns in the consumption measurement 404.

It has been discovered that the combined-state consumption 444 provides enhanced usability and reduces complexity for the computing system 100. The consumption model 424 including the combined-state consumption 444 can reduce the total number of states modeled and reduce the data necessary. Moreover, the consumption model 424 can combine numerous variants or conditions for a state, an action, or a process, further simplifying the number of states.

Referring now to FIG. 9, therein is shown a detailed example of the consumer module 706. The consumer module 706 can include a user identification module 902, a customization module 904, or a combination thereof.

The user identification module 902 can be coupled to the customization module 904. The customization module 904 can include a model adjustment module 906, a personal estimation module 908, an application adjustment module 910, or a combination thereof. The model adjustment module 906 can be coupled to the personal estimation module 908, which can be further coupled to the application adjustment module 910. The modules can be coupled in variety of ways as described above between the analysis module 702 of FIG. 7 and the development module 704 of FIG. 7.

The user identification module 902 is configured to identify the user. The user identification module 902 can communicate, such as by receiving, displaying, determining, or a combination processes thereof, for user's identification information. The user identification module 902 can communicate by accessing the historical user-feedback 456 of FIG. 4. The user identification module 902 can also communicate using the identification portion 604 of FIG. 6 to interact with the user.

The user identification module 902 can further display the application identification 606 of FIG. 6, the user profile 452 of FIG. 4, the device profile 450 of FIG. 4, or a combination thereof through the identification portion 604. For example, the user identification module 902 can display user name, account number, sign-in information, user's device information, application name, developer identification, or a combination thereof.

The user identification module 902 can use the first user interface 218 of FIG. 2, the second user interface 238 of FIG. 2, or a combination thereof communicate various identification information with the user. The user identification module 902 can further use the first control unit 212 of FIG. 2, the second control unit 234 of FIG. 2, or a combination thereof to identify the association or correlation between the identification information and various profiles and models.

The user identification module 902 can further identify detailed data corresponding to the application identification 606. For example, the user identification module 902 can use the first storage interface 224 of FIG. 2, the second storage interface 248 of FIG. 2, the first communication unit 216 of FIG. 2, the second communication unit 236 of FIG. 2, or a combination thereof to access and identify the consumption model 424 of FIG. 4, the application code 502 of FIG. 5, or a combination thereof corresponding to the application identification 606.

After identifying the various data, the user, the device, or a combination thereof, the control flow 900 can pass to the customization module 904. The control flow 900 can pass similarly as described above between the target identification module 710 of FIG. 7 and the replacement identification module 712 of FIG. 7.

The customization module 904 is configured to communicate information associated with resource consumption applicable specifically to the user. The customization module 904 can communicate estimated consumption according to the user's usage habits or user's device. The customization module 904 can further provide the application 302 of FIG. 3 configured to optimize the resource consumption thereof specifically for the user or the user's devices. The customization module 904 can include the model adjustment module 906, the personal estimation module 908, the application adjustment module 910, or a combination thereof.

The model adjustment module 906 is configured to determine an applicable instance of the consumption model 424 corresponding to the application 302. The computing system 100 can include multiple instances of the consumption model 424 based on different environmental or configuration factors. For example, the computing system 100 can include the consumption model 424 corresponding to a unique instance of the first device 102 of FIG. 1, such as for different manufacturers or different device models, the implementation portion 314 of FIG. 3, such as for operating system or driver release, the replacement code 534 controlled by the consumer environment 602 of FIG. 6, or a combination thereof.

The model adjustment module 906 can use the first control unit 212, the second control unit 234, or a combination thereof to determine the applicable instance of the consumption model 424. The model adjustment module 906 can determine the applicable instance based on matching the device profile 450, the user profile 452, the application identification 606, identification information for the first device 102, one or more of the components 231 therein, the implementation portion 314 therein, or a combination thereof.

For example, the model adjustment module 906 can determine the consumption model 424 corresponding to the first device 102 owned by the user or intended to implement the application 302, one or more of the components 231 therein, or a combination thereof. Also for example, the model adjustment module 906 can adjust a baseline instance of the consumption model 424 according to the first device 102 owned by the user or intended to implement the application 302, one or more of the components 231 therein, or a combination thereof.

The model adjustment module 906 can communicate the appropriate instance of the consumption model 424. The model adjustment module 906 can communicate the consumption model 424 between devices, to the user, or a combination thereof. The model adjustment module 906 can communicate the consumption model 424 using the first communication unit 216, the second communication unit 236, the first user interface 218, the second user interface 238, or a combination thereof. The model adjustment module 906 can further communicate the consumption module 728 through the descriptive portion 608 of FIG. 6 for the consumer environment 602.

The personal estimation module 908 is configured to analyze usage of the first device 102. The personal estimation module 908 can calculate the average usage 610 of the user or the first device 102 as a category, a type, or a pattern of usage. The personal estimation module 908 can calculate the average usage 610 using a variety of methods based on the device profile 450, the user profile 452, or a combination thereof.

For example, the personal estimation module 908 can calculate the average usage 610 as the most frequently used instance of the application call 408, the system call 412, or a combination thereof. Also for example, the personal estimation module 908 can calculate the average usage 610 based on determining a categorization, a characterization, or a combination thereof for the user, such as based on demographic or professional information, using the user profile 452, the device profile 450, or a combination thereof. Also for example, the personal estimation module 908 can identify specific patterns or types of usage based on historical usage information according to the user profile 452, the device profile 450, or a combination thereof.

The personal estimation module 908 can further apply the average usage 610 to the consumption model 424 to adjust the consumption rating 448 of FIG. 4 for the application 302 specific to the user or the user's device. For example, based on the user's common usage pattern or location, the application 302 can be estimated to likely utilize WiFi to communicate with another user instead of cellular communication mechanism. The personal estimation module 908 can recalculate or adjust the consumption rating 448 according to the average usage 610.

The personal estimation module 908 can calculate the average usage 610, recalculate or adjust the consumption rating 448, or a combination thereof using the first control unit 212, the second control unit 234, or a combination thereof. The personal estimation module 908 can communicate the updated instance of the consumption rating 448 using the first user interface 218, the second user interface 238, the first communication unit 216, the second communication unit 236, or a combination thereof. The personal estimation module 908 can further communicate the updated or personalized instance of the consumption rating 448 through the descriptive portion 608 of the consumer environment 602.

The application adjustment module 910 is configured to adjust or customize the application 302. The application adjustment module 910 can identify the target code 506 or the target section 504 based on the average usage 610, the user profile 452, the device profile 450, or a combination thereof.

The application adjustment module 910 can determine the target code 506 and the replacement code 534 within the application code 502 for customizing the application 302 specific to the first device 102 owned by the user or intended to implement the application 302, one or more of the components 231 therein, or a combination thereof. The application adjustment module 910 can further identify the target code 506 or the target section 504 affecting or relevant to the average usage 610.

The application adjustment module 910 can identify the target code 506 or the target section 504 based on associations or correlations as described by the consumption model 424. The application adjustment module 910 can further identify the target code 506 or the target section 504 based on patterns, clustering, or a combination thereof between the average usage 610 of the user and portions of the application code 502, the replacement code 534, the application call 408 associated thereto, or a combination thereof. The application adjustment module 910 can further identify the target code 506 or the target section 504 similar to the code identification module 720 of FIG. 7 as described above.

The application adjustment module 910 can similarly identify the replacement code 534 associated with the target code 506, the target section 504, the average usage 610, the device profile 450, the user profile 452, or a combination thereof. The application adjustment module 910 can also calculate the consumption estimate 508 accordingly as described above for the estimation module 714. The application adjustment module 910 can identify the replacement code 534 optimizing the resource consumption similar to the replacement module 734 described above.

The application adjustment module 910 can generate the application 302 based on the application code 502 including the replacement code 534 instead of the target code 506 or the target section 504 for customizing the application 302. The application adjustment module 910 can also select or identify an instance of the application 302 including the replacement code 534 corresponding to the user profile 452, the device profile 450, the average usage 610, or a combination thereof for customizing the application 302 to optimize the resource consumption.

The application adjustment module 910 can generate the customized instance of the application 302 using the first control unit 212, the second control unit 234, or a combination thereof. The application adjustment module 910 can communicate the customized instance of the application 302 or information associated therewith using the first user interface 218, the second user interface 238, the first communication unit 216, the second communication unit 236. The application adjustment module 910 can access the information stored in the first storage unit 214, the second storage unit 246, or a combination thereof to generate the customized instance of the application 302.

It has been discovered that the application 302 customized based on the user profile 452 and the device profile 450 provides improved resource optimization for the computing system 100. The application 302 utilizing the replacement code 534 specifically corresponding to the user profile 452, the device profile 450, the average usage 610 associated therewith, or a combination thereof provides personalized optimization for the application 302 utilizing unique habits, environments, patterns, or a combination thereof for the user.

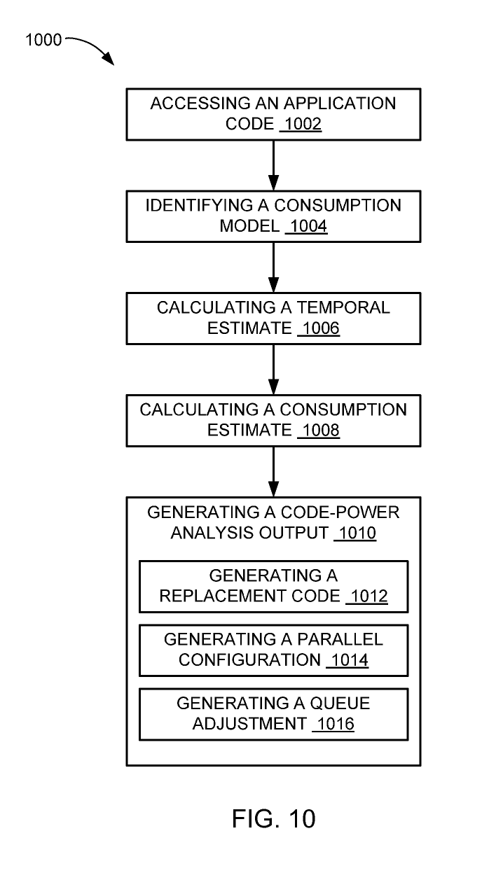

Referring now to FIG. 10, therein is shown an exemplary flow chart 1000 of a method of operation of a computing system in a further embodiment. The computing system 100 can implement the exemplary flow chart 100 as described above in FIGS. 7-9.

The exemplary flow chart 1000 can include accessing an application code including a target code in a box 1002. The computing system 100 can use the target identification module 710 of FIG. 7 to access the application code 502 of FIG. 5 including the target code 506 of FIG. 5, the target section 504 of FIG. 5, or a combination thereof as described above. The computing system 100 can further use the target identification module 710 to identify or select the target code 506, the target section 504, or a combination thereof within the application code 502.

The exemplary flow chart 1000 can further include identifying a consumption model corresponding to the target code in a box 1004. The computing system 100 can identify the consumption model using the replacement identification module 712 of FIG. 7. The computing system 100 can use the replacement identification module 712 to identify the consumption model 424 of FIG. 4 as described above. The computing system 100 can use the replacement identification module 712 to identify the consumption model 424 corresponding to the target code 506, the target section 504, or a combination thereof resulting from the step represented in the box 1002.

The exemplary flow chart 1000 can further include calculating a temporal estimate for the target code based on the consumption model in a box 1006. The computing system 100 can use the estimation module 714 of FIG. 7 to calculate the temporal estimate. The computing system 100 can use the estimation module 714 to calculate the temporal estimate 510 of FIG. 5 for the target code 506, the target section 504, or a combination thereof as described above.

The exemplary flow chart 1000 can further include calculating a consumption estimate for the target code based on the consumption model in a box 1008. The computing system 100 can use the estimation module 714 to calculate the consumption estimate. The computing system 100 can use the estimation module 714 to calculate consumption estimate 508 of FIG. 5 for the target code 506, the target section 504, or a combination thereof based on the consumption model 424 as described above.

The exemplary flow chart 1000 can further include generating a code-power analysis output based on the consumption estimate in a box 1010. The computing system 100 can generate the code-power analysis output using the output module 716 of FIG. 7. The output module 716 can generate the code-power analysis output 526 of FIG. 5 as described above.

The step of generating the code-power analysis output as represented in the box 1010 can further include generating a replacement code for substituting the target code based on lowering the consumption estimate in a box 1012, The output module 716 can further generate the replacement code 534 of FIG. 5 for substituting or replacing the target code 506, the target section 504, or a combination thereof based on lowering or optimizing the consumption estimate 508 of FIG. 5 as described above.

The step of generating the code-power analysis output as represented in the box 1010 can further include generating a parallel configuration for the target code for optimizing the temporal estimate and the consumption estimate in a box 1014. The output module 716 can further generate the parallel configuration 536 of FIG. 5 for substituting or replacing the target code 506, the target section 504, or a combination thereof for lowering or optimizing the temporal estimate 510 and the consumption estimate 508 as described above.

The step of generating the code-power analysis output as represented in the box 1010 can further include generating a queue adjustment for combining one or more tasks, threads, routines, or a combination thereof during execution of an application in a box 1016, or a combination thereof. The output module 716 can generate the queue adjustment 540 of FIG. 5 for combining one or more instances of the task 304 of FIG. 3, the thread 306 of FIG. 3, the routine 308 of FIG. 3, or a combination thereof during execution for the application 302 of FIG. 3 as described above.

The modules described herein can be hardware implementation or hardware accelerators, including passive circuitry, active circuitry, or both, in the first control unit 312 of FIG. 3, the second control unit 234 of FIG. 2, or a combination thereof. The modules can also be hardware implementation or hardware accelerators, including passive circuitry, active circuitry, or both, within the first device 102, the second device 106 of FIG. 1, or a combination thereof but outside of the first control unit 212, the second control unit 234, or a combination thereof.

For illustrative purposes, the various modules have been described as being specific to the first device 102, the second device 106, or a combination thereof. However, it is understood that the modules can be distributed differently. For example, the various modules can be implemented in a different device, or the functionalities of the modules can be distributed across multiple devices. Also as an example, the various modules can be stored in a non-transitory memory medium.

As a more specific example, one or more modules described above can be stored in the non-transitory memory medium for distribution to a different system, a different device, a different user, or a combination thereof. Also as a more specific example, the modules described above can be implemented or stored using a single hardware unit, such as a chip or a processor, or across multiple hardware units.

The modules described in this application can be stored in the non-transitory computer readable medium. The first storage unit 214 of FIG. 2, the second storage unit 246 of FIG. 2, or a combination thereof can represent the non-transitory computer readable medium. The first storage unit 214, the second storage unit 246, or a combination thereof, or a portion therein can be removable from the first device 102, the second device 106, or a combination thereof. Examples of the non-transitory computer readable medium can be a non-volatile memory card or stick, an external hard disk drive, a tape cassette, or an optical disk.

The physical transformation from the application code 502 and the corresponding application 302 results in the movement in the physical world, such as a functionality or a feature utilized by the user. The provided functionality or feature can influence the user's movement or usage, such as interacting with other users or availing contact or information to other users. Movement in the physical world results in consumption of the resources, which can be fed back into the computing system 100 through the historical user-feedback 456, the consumption measurement 404, the user profile 452, the device profile 450, or a combination thereof to further process the code-power analysis output 526 for optimizing the resource consumption.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While embodiments of the invention have been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a storage interface configured to access an application code including a target code;
a control unit, coupled to the storage interface, configured to:
identify a consumption model corresponding to the target code,
calculate a consumption estimate for the target code based on the consumption model, and
generate a code-power analysis output based on the consumption estimate.

2. The system as claimed in claim 1 wherein the control unit is configured to generate the code-power analysis output by generating a replacement code for substituting the target code based on lowering the consumption estimate.

3. The system as claimed in claim 1 wherein the control unit is further configured to:
calculate a temporal estimate for the target code based on the consumption model; and
generate the code-power analysis output by generating a parallel configuration for the target code for optimizing the temporal estimate and the consumption estimate.

4. The system as claimed in claim 1 wherein the control unit is configured to generate the code-power analysis output including a queue adjustment for combining tasks, threads, routines, or a combination thereof during execution of an application.

5. The system as claimed in claim 1 wherein the control unit is configured to generate the code-power analysis output by generating a sequential adjustment for the target code for sequentially reordering the target code within the application code based on lowering the consumption estimate.

6. The system as claimed in claim 1 wherein the control unit is configured to generate the code-power analysis output by calculating a relative-highest section within the application code.

7. The system as claimed in claim 1 wherein the control unit is configured to generate the code-power analysis output by calculating a threshold breach for the target code.

8. The system as claimed in claim 1 wherein the control unit is configured to generate the code-power analysis output for combining one or more tasks, threads, routines, or a combination thereof based on the consumption estimate.

9. The system as claimed in claim 1 wherein the control unit is configured to calculate the consumption estimate based on a historical user-feedback.

10. A method of operation of a computing system comprising:
accessing an application code including a target code;
identifying a consumption model corresponding to the target code;
calculating a consumption estimate for the target code based on the consumption model; and
generating a code-power analysis output with a control unit based on the consumption estimate.

11. The method as claimed in claim 10 wherein generating the code-power analysis output includes generating a replacement code for substituting the target code based on lowering the consumption estimate.

12. The method as claimed in claim 10 further comprising:
calculating a temporal estimate for the target code based on the consumption model;
wherein:
generating the code-power analysis output includes generating a parallel configuration for the target code for optimizing the temporal estimate and the consumption estimate.

13. The method as claimed in claim 10 wherein generating the code-power analysis output includes generating a queue adjustment for combining one or more tasks, threads, routines, or a combination thereof during execution of an application.

14. A non-transitory computer readable medium including instructions for a computing system comprising:
accessing an application code including a target code;
identifying a consumption model corresponding to the target code;
calculating a consumption estimate for the target code based on the consumption model; and
generating a code-power analysis output with a control unit based on the consumption estimate.

15. The non-transitory computer readable medium as claimed in claim 14 wherein generating the code-power analysis output includes generating a replacement code for substituting the target code based on lowering the consumption estimate.

16. The non-transitory computer readable medium as claimed in claim 14 further comprising:
calculating a temporal estimate for the target code based on the consumption model;
wherein:
generating the code-power analysis output includes generating a parallel configuration for the target code for optimizing the temporal estimate and the consumption estimate.

17. The non-transitory computer readable medium as claimed in claim 14 wherein generating the code-power analysis output includes generating a queue adjustment for combining one or more tasks, threads, routines, or a combination thereof during execution of the application.

18. A graphic user interface to exchange information related to an application, the graphic user interface displayed on a user interface of a device, comprising:
an identification portion configured to display an application identification and a user profile; and
a descriptive portion configured to display:
an average usage corresponding to the user profile and the application identification, and
a consumption rating associated with the average usage, the consumption rating for representing a consumption model corresponding to the user profile and the application identification.

19. A computing system comprising:
a sensor configured to determine a consumption measurement for representing a device executing an application;
a control unit, coupled to the sensor, configured to:
identify an input sequence corresponding to the consumption measurement,
generate a state model based on the consumption measurement, the input sequence, or a combination thereof, and
generate a consumption model based on the state model for representing the application based on the device.

20. The system as claimed in claim 19 wherein the control unit is configured to generate the consumption model based on a combined-state consumption, a state-decomposition consumption, or a combination thereof.
